(19) United States
(12) Patent Application Publication
(10) Pub. No.: US 2016/0093144 A1
(43) Pub. Date: Mar. 31, 2016

(54) GAMING MACHINE THAT CHANGES COLOR OF SYMBOL IN REARRANGING SYMBOLS

(71) Applicants: UNIVERSAL ENTERTAINMENT CORPORATION, Tokyo (JP); ARUZE GAMING AMERICA, INC., Las Vegas, NV (US)

(72) Inventors: Kenta KITAMURA, Tokyo (JP); Kenji ENOKIDO, Tokyo (JP); Tatsuya TERANISHI, Tokyo (JP); Takaki NARITA, Tokyo (JP)

(21) Appl. No.: 14/860,839

(22) Filed: Sep. 22, 2015

(30) Foreign Application Priority Data
Sep. 26, 2014 (JP) 2014196027

(51) Int. Cl. G07F 17/32

(52) U.S. Cl. CPC G07F 17/3213; G07F 17/3258

(57) ABSTRACT

Provided is a gaming machine that is capable of increasing the kind of winning patterns and the kind of payouts by substantially increasing the kind of symbols even though the gaming machine is equipped with real reels. The gaming machine increases the kind of symbols by (A-1-1) of determining a color selection tendency by lottery with reference to a color selection tendency determination table; (A-1-2) of determining one color determination table from a plurality of color determination tables in accordance with the color selection tendency determined in the (A-1-1); and (A-1-3) of determining a color for decorating a symbol or a background of the symbol by lottery with reference to the one color determination table determined in the (A-1-2).

### CROSS-REFERENCE TO RELATED APPLICATIONS

This application claims the benefit of Japanese Patent Application No. 2014-196027 filed on Sep. 26, 2014, which application is incorporated herein by reference in its entirety.

### TECHNICAL FIELD

The present invention relates to a gaming machine that rearranges symbols.

### BACKGROUND ART

Traditional slot machines have been known that mechanically drive substantial reels with motors to rearrange symbols (for example, refer to US Patent Application Publication No. 2013/0288774).

In such a slot machine, a plurality of symbols are physically disposed on the reels. Since the reels are real, it is extremely difficult to change the size of the reels with progress of the games. Accordingly, the kinds and the numbers of symbols allowed to be disposed on the reels have to be limited.

### SUMMARY OF INVENTION

### Technical Problem

As mentioned above, the kinds and the numbers of symbols allowed to be disposed on the substantial reels are limited. For this reason, the number of winning patterns and kinds of payout has to be small, as well as the number of kinds of symbols disposed on the reels.

The present invention has been accomplished in view of the foregoing problems and an object of the present invention is to provide a gaming machine that can substantially increase the kinds of symbols so that the kinds of winning patterns and the kinds of payout can be increased even though the gaming machine is equipped with real reels.

### Solution to Problem

The first embodiment of the present invention is a gaming machine comprising:

a symbol display device for displaying a game result by rearranging a plurality of symbols;

a controller for executing games; and

a memory holding a plurality of tables.

The plurality of tables includes:
a plurality of color determination tables for determining a color for decorating a symbol or a background of the symbol, and
a color selection tendency determination table for determining one color selection tendency from a plurality of color selection tendencies in determining a color for decorating a symbol or a background of the symbol;

the plurality of color selection tendencies include a color selection tendency to select one color out of a plurality of selectable colors with high probability;

the plurality of color determination tables are defined to have different color selection tendencies; and

the controller is programmed to perform the following processing of:

(A-1-1) determining a color selection tendency by lottery with reference to the color selection tendency determination table,

(A-1-2) determining one color determination table from the plurality of color determination tables in accordance with the color selection tendency determined in the processing of (A-1-1), and

(A-1-3) determining a color for decorating a symbol or a background of the symbol by lottery with reference to the color determination table determined in the processing of (A-1-2).

Since the gaming machine determines a color selection tendency and then determines a color determination table based on the color selection tendency, a color can be determined by differently weighted selection or by approximately equally weighted selection. Furthermore, since the gaming machine determines a color from a color determination table after determining a color selection tendency, determining a color can be diversified. This determining a color for a symbol substantially increases the kinds of symbols by selecting different colors for a symbol even if the character or picture of the symbol is the same.

In the second embodiment of the present invention,

the plurality of tables further includes:
a symbol array table for defining a plurality of symbol arrays including the plurality of symbols, and
a color determination table combination table for specifying combinations of color determination tables associated with the plurality of symbol arrays one by one.

The gaming machine assigns different color determination tables to the plurality of symbol arrays to separately determine colors for the plurality of symbol arrays, which allows various winning patterns to be provided. The gaming machine can have more kinds of winning patterns and more kinds of payouts.

In the third embodiment of the present invention,

the controller is programmed to further perform the following processing of:

(B-1-1) accumulating a part of credits bet for each of the games, and

(B-1-2) providing the part of the credits accumulated in the processing of (B-1-1) in a form of a progressive payout when a predetermined winning pattern is completed with a specific kind of one or more symbols for which colors are determined with color determination tables.

Since more kinds of symbols are attained with the colors, a winning pattern to provide a progressive payout can be defined, so that more kinds of payouts can be provided.

In the fourth embodiment of the present invention,

the games include games in a base game mode requiring a bet and games in a free game mode requiring no bet;

the plurality of tables further include a free game mode table for determining a color for decorating a specific kind of symbols in the free game mode; and

the controller is programmed to further perform the following processing of:
(C-1-1) determining a color for decorating all symbols of the specific kind with reference to the free game mode table when a game in the free game mode is being executed.

Since the free game mode is configured to determine colors of symbols in accordance with a different way of determining colors from the base game mode, winning patterns and payouts in the free game mode can be defined separately.

### Advantageous Effects of Invention

Even in a gaming machine equipped with real reels, the kinds of symbols can be substantially increased so that more kinds of winning patterns and more kinds of payout can be attained.

### BRIEF DESCRIPTION OF DRAWINGS

FIG. 1 is a drawing for illustrating an overview of a gaming machine;

FIG. 2 is an elevation view of a slot machine;

FIG. 3 is a perspective view of the slot machine;

FIG. 4 is a perspective view of a control panel;

FIG. 5 is a block diagram of a circuitry of the slot machine;

FIG. 6 is a block diagram of a circuitry of the slot machine;

FIG. 7 is a block diagram of a circuitry of an AP-X motherboard;

FIG. 8A and FIG. 8B provide perspective view of a front light and a perspective view of a backlight;

FIG. 9 is a diagram of a general configuration of a game system;

FIG. 10 is a block diagram of the game system;

FIG. 11 is a block diagram of a PTS system;

FIG. 12 is a diagram for illustrating state transitions in the gaming machine;

FIG. 13 is a view of an example of a payline definition table;

FIG. 14 is a view of an example of a payout table;

FIG. 15 is a view of a configuration of reel strips;

FIG. 16 is a view of a configuration of reel strips;

FIG. 17 is a view of a configuration of reel strips;

FIG. 18 is a view of a configuration of reel strips;

FIG. 19 is a flowchart of main control processing in the gaming machine;

FIG. 20 is a flowchart of coin-insertion/start check processing;

FIG. 21 is a flowchart of base game mode symbol lottery processing;

FIG. 22 is a flowchart of symbol display control processing;

FIG. 23 is a flowchart of payout determination processing;

FIG. 24 is a flowchart of free game mode processing;

FIG. 25 is a flowchart of free game mode symbol lottery processing;

FIG. 26 is a flowchart of color table determination processing;

FIG. 27 is a flowchart of color determination processing;

FIG. 28 is a table providing an example of a feature pattern table determination table;

FIG. 29 is a table providing an example of a reel pattern determination table;

FIG. 30 is a table providing an example of a reel pattern determination table;

FIG. 31 is a table providing an example of a reel pattern determination table;

FIG. 32 is a table providing an example of a color table collection;

FIG. 33 is a table providing an example of a free game color determination table;

FIG. 34A and FIG. 34B provide tables of an example of feature pattern ID and an example of a reel pattern determination table;

FIG. 35 is a table providing an example of color tables;

FIG. 36A and FIG. 36B are tables providing a color table for determining colors for the mech reel M3a;

FIG. 37A and FIG. 37B are tables providing a color table for determining colors for the mech reel M3b;

FIG. 38A and FIG. 38B are tables providing a color table for determining colors for the mech reel M3c;

FIG. 39A and FIG. 39B are tables providing a color table for determining colors for the mech reel M3d;

FIG. 40A and FIG. 40B are tables providing a color table for determining colors for the mech reel M3e;

FIG. 41 is a table showing symbols on the five mech reels M3a to M3e in which colors of all the 7s are determined;

FIG. 42 is a table providing kinds of progressive jackpots;

FIG. 43A and FIG. 43B provides tables showing an example of completion of a progressive jackpot; and

FIG. 44 is a table indicating payouts for progressive jackpots.

### DESCRIPTION OF EMBODIMENTS

### Overview of Gaming Machine in Embodiment

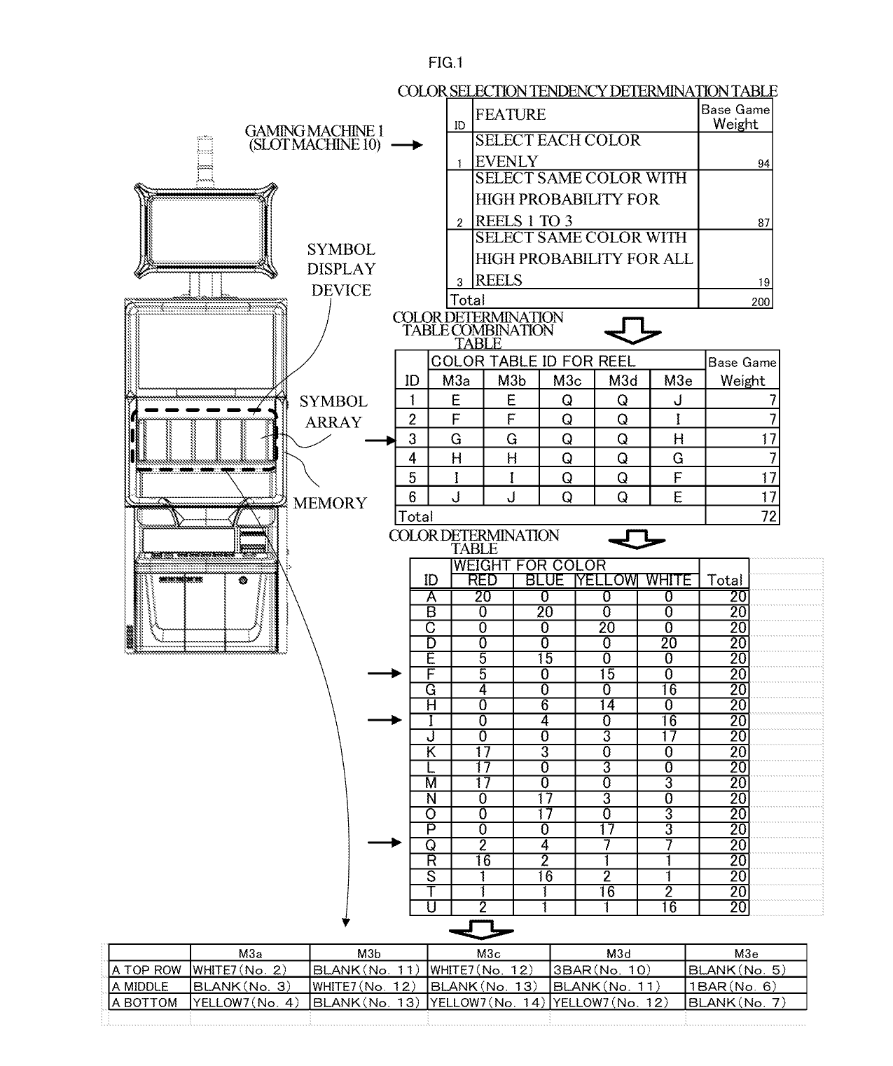

FIG. 1 is a drawing for illustrating an overview of a gaming machine in the present embodiment.

The gaming machine in the present embodiment is a gaming machine comprising:

a symbol display device for displaying a game result by rearranging a plurality of symbols;

a controller for executing games; and

a memory holding a plurality of tables.

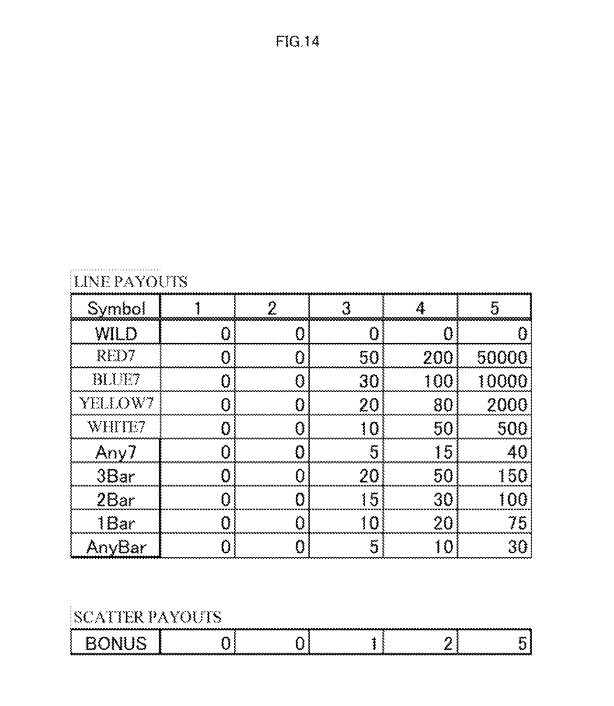

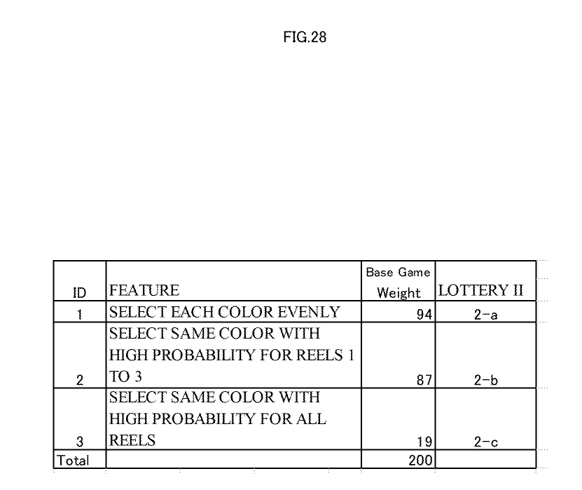

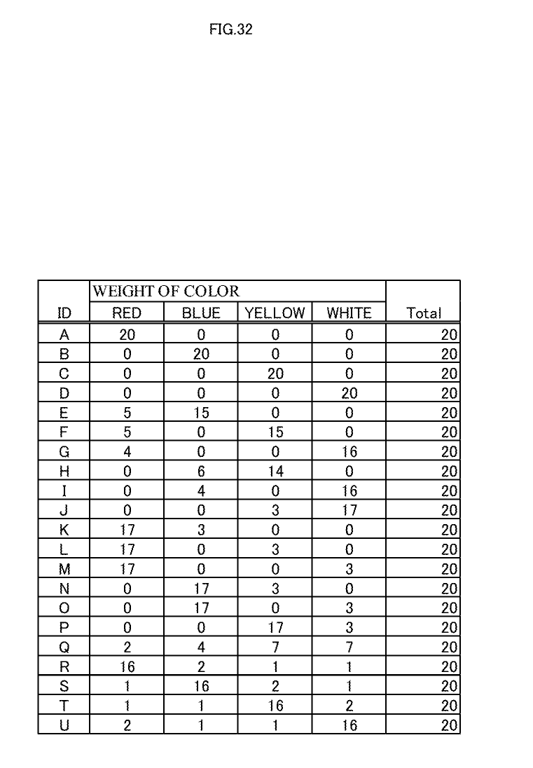

The plurality of tables includes:
a plurality of color determination tables (e.g., a color table collection illustrated in FIG. 32 to be described later) for determining a color for decorating a symbol or a background of the symbol,
a color selection tendency determination table (e.g., a feature pattern table determination table illustrated in FIG. 28 to be described later) for determining one color selection tendency from a plurality of color selection tendencies in determining a color for decorating a symbol or a background of the symbol, and a winning pattern identification table (e.g., a payout table illustrated in FIG. 14 to be described later) for identifying a winning pattern based on a color for decorating a symbol or a background of the symbol;

the plurality of color selection tendencies include a color selection tendency to select one color out of a plurality of selectable colors with high probability;

the plurality of color determination tables are defined to have different color selection tendencies; and

the controller is programmed to perform the following processing of:

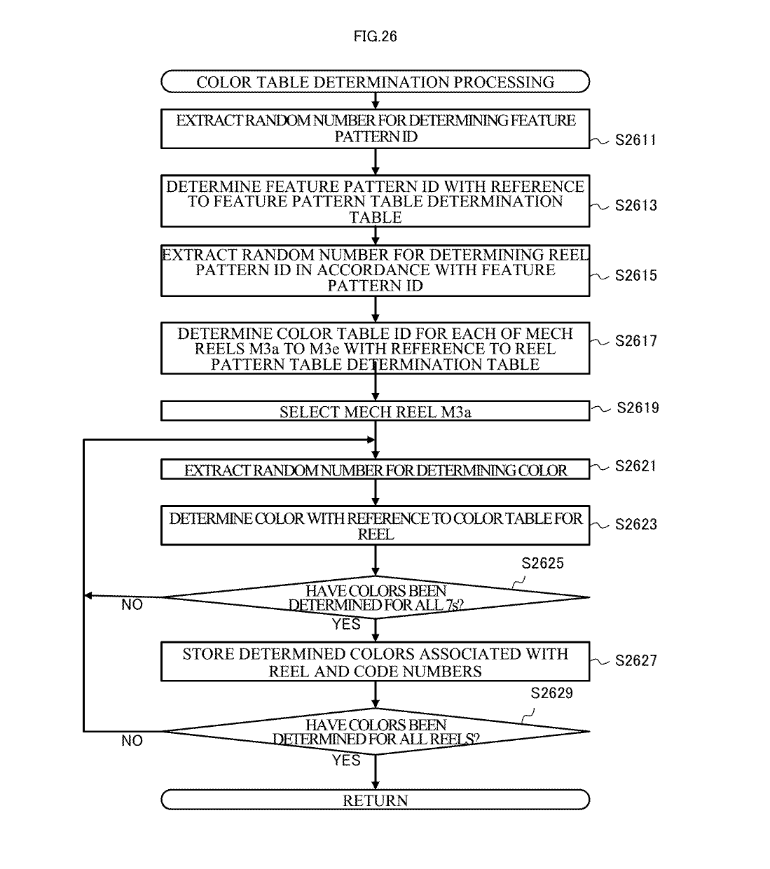

(A-1-1) determining a color selection tendency by lottery with reference to the color selection tendency determination table (e.g., steps S2611 and S2613 in FIG. 26),

(A-1-2) determining one color determination table from the plurality of color determination tables in accordance with the color selection tendency determined in the processing of (A-1-1) (e.g., steps S2615 and S2617 in FIGS. 26), and

(A-1-3) determining a color for decorating a symbol or a background of the symbol by lottery with reference to the one color determination table determined in the processing of (A-1-2) (e.g., steps S2621 and S2623 in FIG. 26).

A symbol or the background of the symbol is decorated with the color determined with a color table. Decoration with a color can be made by illuminating the symbol or the background with light emitted from a light source such as a backlight or by showing an image on a display. The way of decoration is not limited as far as the player can recognize that a color for a symbol is determined or that a color for a symbol is changed to a different color.

Since the gaming machine determines a color selection tendency and then determines a color determination table based on the color selection tendency, a color can be determined by differently weighted selection or by approximately equally weighted selection. In selecting one color from the first to the fifth colors, if the determined color selection tendency is differently weighted selection to select the first color or the second color with high probability, the gaming machine can be arranged to select the first color or the second color with high probability and to select one of the remaining third to fifth colors with low probability. If the determined color selection tendency is approximately equally weighted selection, the gaming machine can be arranged to select one of the first to the fifth colors with approximately equal probability.

The color selection tendency determination table is a table in which the probability of selecting one color from a plurality of colors is specified to be high. Accordingly, the color selection tendency determination table specifies a high weight for one color among the plurality of colors. The gaming machine first determines a color selection tendency and then determines a specific color based on the color selection tendency. Determining a color in this way can substantially increase kinds of symbols with different colors even if the character or picture is the same.

In the gaming machine in the present embodiment,

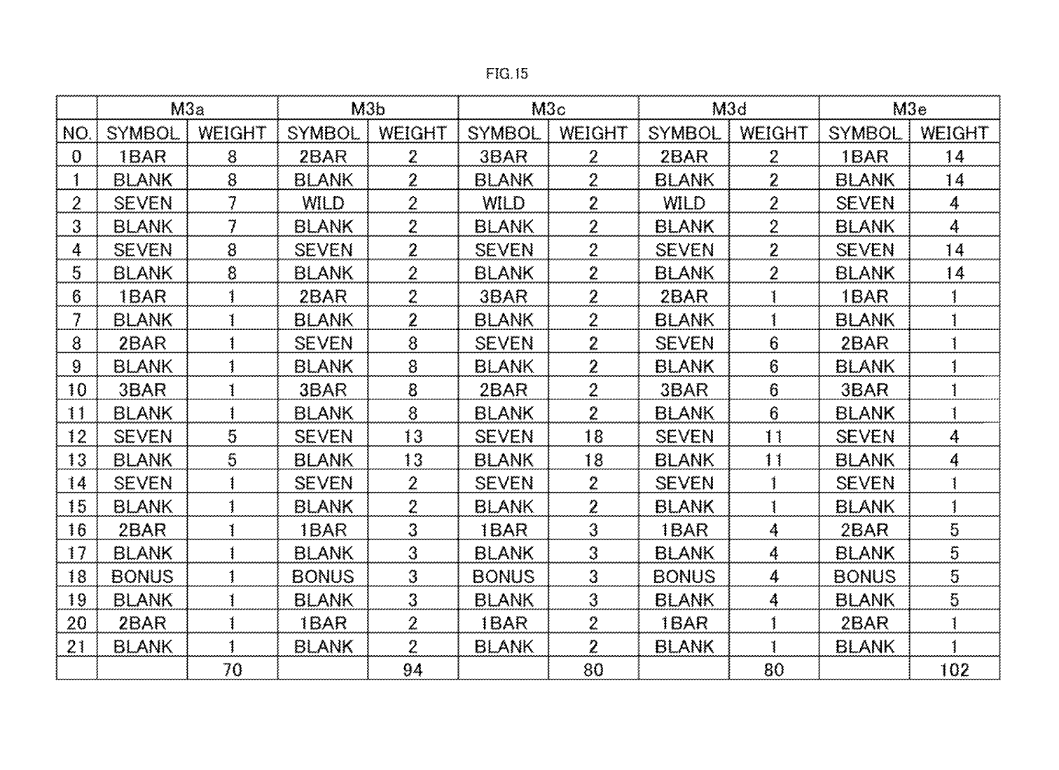

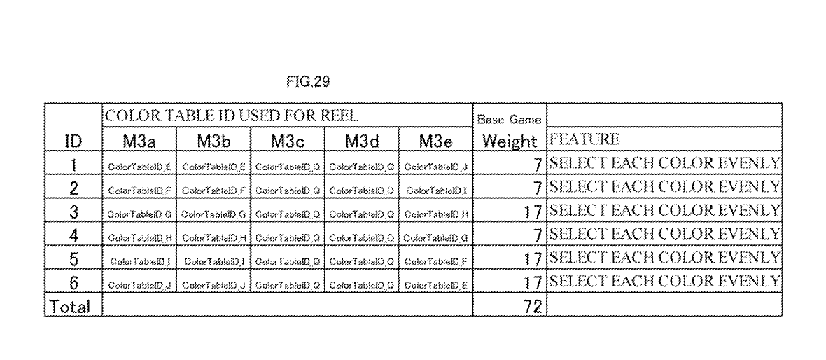

the plurality of tables further includes:
a symbol array table (e.g., reel strips illustrated in FIG. 15 to be described later) for defining a plurality of symbol arrays including the plurality of symbols, and
a color determination table combination table (e.g., reel pattern determination tables illustrated in FIGS. 29 to 31 to be described later) for specifying combinations of color determination tables associated with the plurality of symbol arrays one by one.

The gaming machine assigns different color determination tables to the plurality of symbol arrays to separately determine colors for the plurality of symbol arrays, which allows various winning patterns to be provided. The gaming machine can have more kinds of winning patterns and more kinds of payouts.

The color determination table combination table may be composed of a plurality of table collections (e.g., the individual tables of FIGS. 29 to 31 to be described later) each associated with a color determination tendency;

each of the plurality of table collections includes tables each specifying a combination of color determination tables associated with the plurality of symbol arrays one by one; and

the controller is programmed to perform the following processing of:
selecting one table collection associated with the determined color selection tendency,
selecting one table (one of the tables having IDs 1 to 40 in FIGS. 29 to 31) from the selected one table collection, and
determining a color for each of the plurality of symbol arrays based on a color determination table (one of the tables having IDs A to U in FIG. 32) specified in the selected one table.

The gaming machine in the present embodiment performs the following processing to determine colors for decorating symbols disposed on a plurality of symbol arrays or the backgrounds of those symbols.

First, the gaming machine determines a color selection tendency with reference to the color selection tendency determination table. Determining a color selection tendency determines the policy to determine colors, by either differently weighted selection or approximately equally weighted selection.

Next, the gaming machine determines color determination tables to be used for the plurality of symbol arrays. Since each of the plurality of symbol arrays are assigned a color determination table, differently weighted selection or approximately equally weighted selection can be determined for each symbol array. For example, colors for the first symbol array are determined based on differently weighted selection and colors for the fourth symbol array are determined based on approximately equally weighted selection.

In the gaming machine in the present embodiment, the controller is programmed to further perform the following processing of:

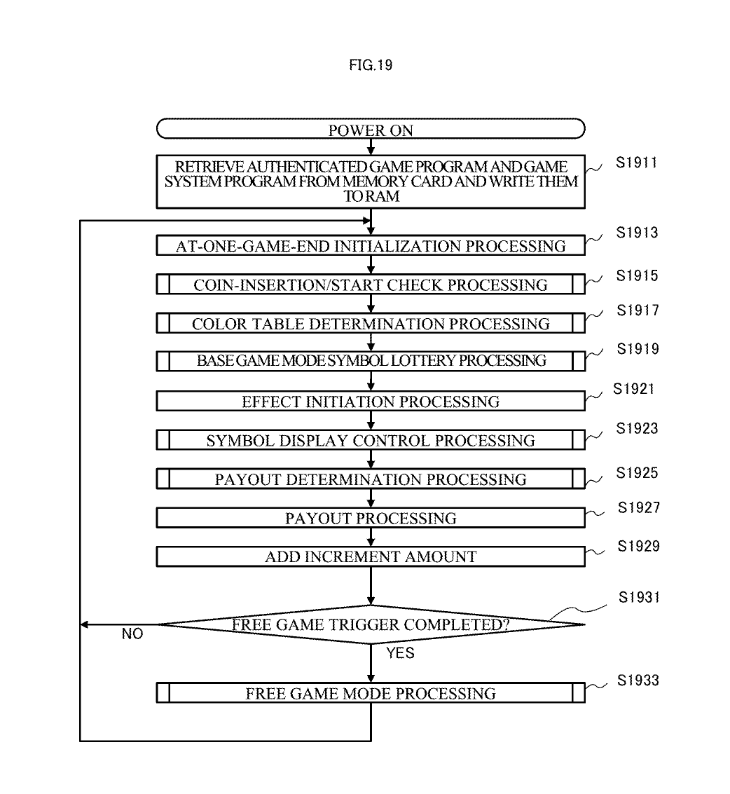

(B-1-1) accumulating a part of credits bet for each of the games (e.g., step S1929 in FIG. 19 to be described later), and

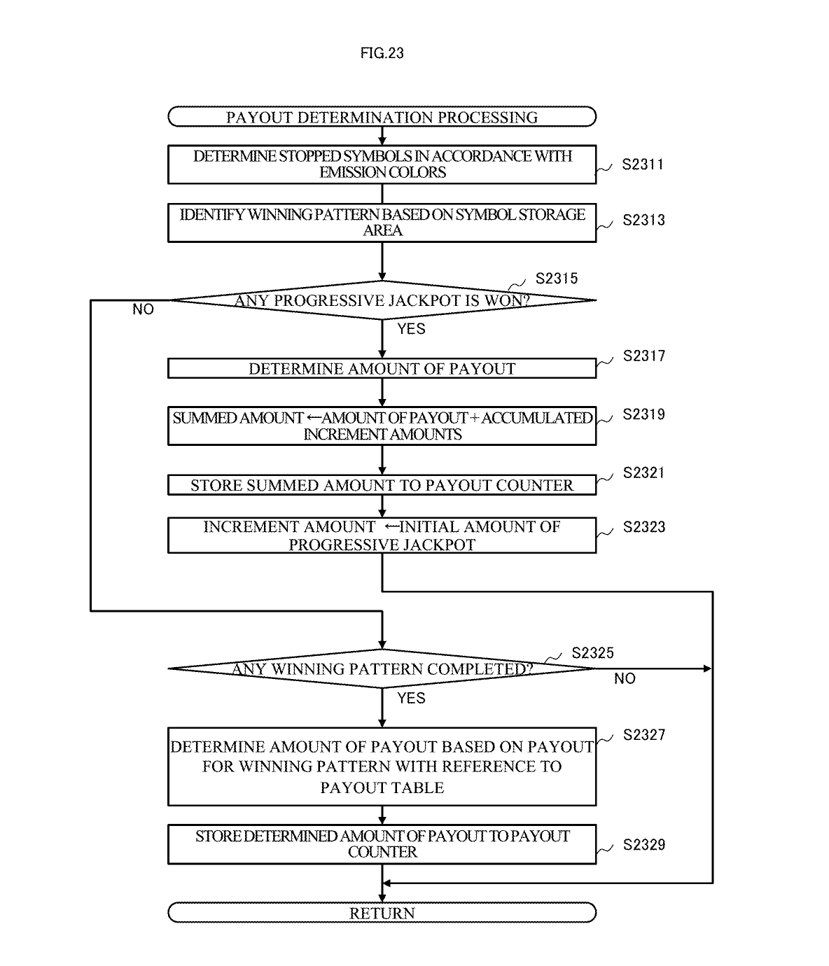

(B-1-2) providing the part of the credits accumulated in the processing of (B-1-1) in a form of a progressive payout when a predetermined winning pattern is completed with a specific kind of one or more symbols for which colors are determined with color determination tables (e.g., steps S2315 to S2323 in FIG. 23 to be described later).

Since more kinds of symbols are attained with the colors, a winning pattern to provide a progressive payout can be defined, so that more kinds of payouts can be provided.

In the gaming machine in the present invention,

the games include games in a base game mode requiring a bet and games in a free game mode requiring no bet;

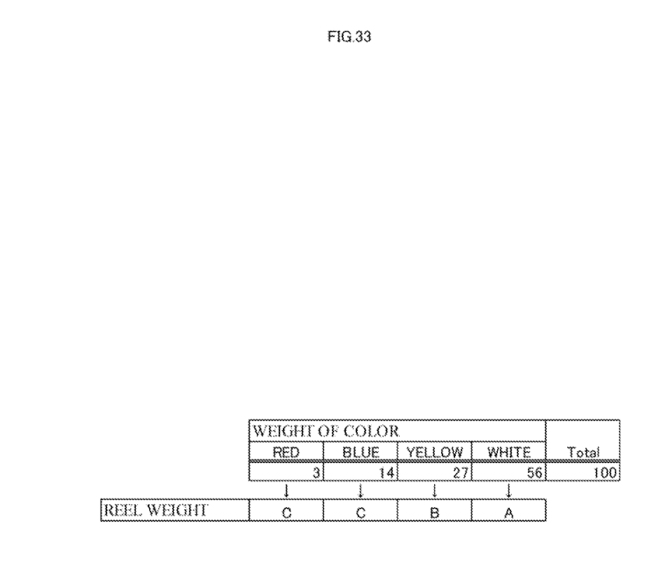

the plurality of tables further include a free game mode table (e.g., a free game color determination table illustrated in FIG. 33 to be described later) for determining a color for decorating a specific kind of symbols in the free game mode; and

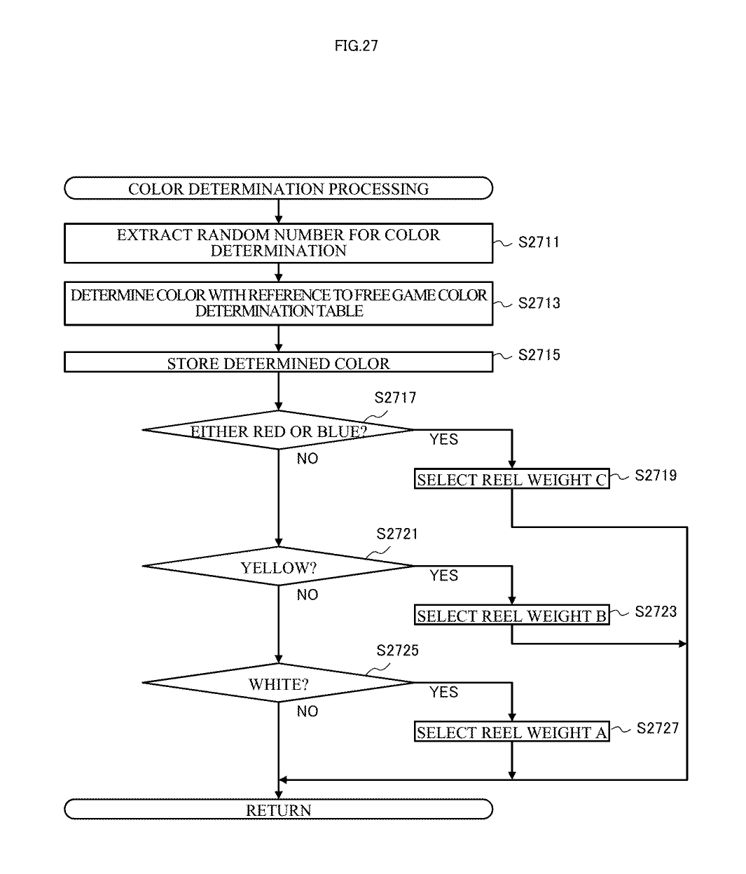

the controller is programmed to further perform the following processing of:
(C-1-1) determining a color for decorating all symbols of the specific kind with reference to the free game mode table when a game in the free game mode is being executed (e.g., processing illustrated in FIG. 27).

Since the free game mode is configured to determine colors of symbols in accordance with a different way of determining colors from the base game mode, winning patterns and payouts in the free game mode can be defined separately.

### <<<Basic Concept>>>

A slot machine 10 is a kind of gaming machine. The present embodiment describes a slot machine 10 as an example of a gaming machine; however, the gaming machine is not limited to this and is satisfactory if the gaming apparatus independently operates a base game mode and develops the base game mode to a different game mode such as free game mode.

Games conducted in the base game mode in the present embodiment are conducted in the slot machine 10. In the present embodiment, games in the base game mode are referred to as base games. The base games are slot games that rearrange a plurality of symbols each time. The base games are games conceptually distinguished from free games.

Specifically, rearranging symbols in a slot game is performed by five reels M3a to M3e (hereinafter referred to as mech reels M3a to M3e) which can be mechanically rotated and stopped by activation and deactivation of motors. The symbols to be rearranged are stopped and shown in a symbol display area 141d of a lower display unit 141.

The slot games are categorized into base game mode and free game mode. The base game mode is to conduct unit games (base games or slot games) under the condition that a gaming medium (gaming value) is bet. Each unit game rearranges symbols in the symbol display area 141d and provides a normal payout in accordance with the rearranged symbols. The games in the base game mode are not limited to slot games and are satisfactory if the games can be conducted in a game terminal like a slot machine 10.

When a unit game starts, an arrangement of a set of symbols is released. The releasing the arrangement of symbols starts to show the symbols as being shuffled. After a predetermined time, the symbols are stopped. Stopping the symbols rearranges another set of symbols. Rearranging the symbols provides the result of the unit game. In the present embodiment, stopping symbols means showing the symbols (appearance of the symbols) on the display. Rearranging symbols forms a symbol matrix.

The free game mode is to conduct unit games (free games) when symbols rearranged in a base game mode satisfy a predetermined condition. Each unit game rearranges symbols under conditions different from those of a base game and provides a payout in accordance with the rearranged symbols.

Symbols are rearranged to be seen in the symbol display area 141d; they are not limited in kind or number. Symbol is a general concept of special symbol and normal symbol. Special symbols are added to normal symbols as necessary.

For example, special symbols include wild symbols (such as WILDs, which are described later) and trigger symbols (such as BONUSes, which are described later). Wild symbols are symbols that can substitute for other kinds of symbols. Wild symbols are replaced with other kinds of symbols to make an advantageous winning pattern. Trigger symbols are to be a trigger to start bonus games. Trigger symbols may have another function to increase special symbols in the bonus games, that is, to increase the special symbols of at least either trigger symbols or wild symbols. Alternatively, trigger symbols may have another function to increase bonus games in the bonus game mode.

Specifically, the term “symbol” is a generic term for a WILD (wild symbol), a RED7, a BLUE7, a YELLOW7, a WHITE7, a 3BAR, a 2BAR, a 1BAR, a BONUS (trigger symbol), or a BLANK. The symbols in the present embodiment include BLANKs (blank symbols).

The BLANKs are symbols that will not be a constituent of a winning pattern. Accordingly, if a plurality of BLANKs are lined along a payline, they do not function as normal symbols to form a winning pattern. The BLANKs do not function as scatter symbols, either; if a plurality of BLANKs appear independently from a payline, they do not form a winning pattern.

A BLANK disposed on a mech reel functions as a symbol for controlling the stop position of the mech reel within the symbol display area 141d. The BLANKs are symbols for stop control of a mech reel; they are not taken into account in winning pattern identification even if they appear (are rearranged) in the symbol display area 141d.

In the present embodiment, the BLANKs do not include any picture or mark, making the player see that the BLANKs do not form a winning pattern. For example, the BLANKs are preferably in a single color, but include areas that can be recognized as a single-colored area where, even if some decorative pattern or picture is provided, most of the area is in a single color or otherwise the color of the pattern or picture is pale.

The gaming value includes coins, bills, and electrically valuable information equivalent to these. The gaming value in the present embodiment is not specifically limited and can be gaming media such as medals, tokens, electric money, and tickets. The tickets are not specifically limited and may be later-described tickets with barcodes.

Bonus games mean feature games. For example, bonus games may be unit games repeated in a free game mode. Bonus games can be any kind of games as far as the bonus games are advantageous over games in the base game mode. If the games are advantageous for the player, or if the games are advantageous over games in the base game mode, a plurality of kinds of bonus games may be mixed. For example, bonus games may be provided in one of the conditions or in combination of the conditions that more gaming value can be acquired than in the base game mode, that gaming value can be acquired at higher probability than in the base game mode, and that less gaming value is spent than in the base game mode.

Games in a free game mode (bonus games) may be any kind of games as far as they are different from base games. In the present embodiment, free games are conducted as bonus games. Free games can be conducted with a smaller bet of gaming value than base games and pays gaming value in the amount in accordance with a winning pattern completed with rearranged symbols. In other words, free games can be defined as games that can be started without requiring spending gaming value. “Without requiring spending gaming value” includes a case of zero bet.

Rearranging means an action of arranging symbols in the symbol display area 141d again after releasing an arrangement of symbols. An arrangement of symbols is released by starting a unit game (slot game) and subsequently, another set of symbols are arranged again (rearranged). The rearranged symbols determine a result of the unit game to terminate the unit game. Arrangement means a state in which symbols are visible by the player in the outside. A plurality of symbols rearranged in the symbol display area 141d forms a symbol matrix.

### <<<<Specific Overview of Gaming Machine in Present Embodiment>>>>

An overview of a gaming machine 1 in the present embodiment is as follows. Details are described later.

The gaming machine 1 has five mech reels M3a, M3b, M3c, M3d, and M3e. The five mech reels are rotatably mounted on a lower display unit 141. On each of the five mech reels M3a to M3e, a plurality of symbols are disposed. A part of the plurality of symbols disposed on the five mech reels M3a to M3e appear to be displayed in a symbol display area 141d of the lower display unit 141. The plurality of symbols are disposed along a longitudinal direction of each of the five mech reels M3a to M3e. A part of the plurality of substantial symbols disposed on each of the five mech reels M3a to M3e appear to be displayed in the symbol display area 141d.

The plurality of symbols disposed on a mech reel constitute one reel strip (one symbol array). Five mech reels M3a to M3e provide five reel strips (five symbol arrays). The mech reels M3a to M3e are spun and stopped on the display to scroll the five symbol arrays, forming scroll lines of the symbol arrays. Each reel strip is a physical reel strip and a symbol array means an array formed of a plurality of symbols or data representing the array of the plurality of symbols; in the present embodiment, however, the reel strip and the symbol array may be treated as the same thing. The five reel strips and some reel strips are generally referred to as reel strips.

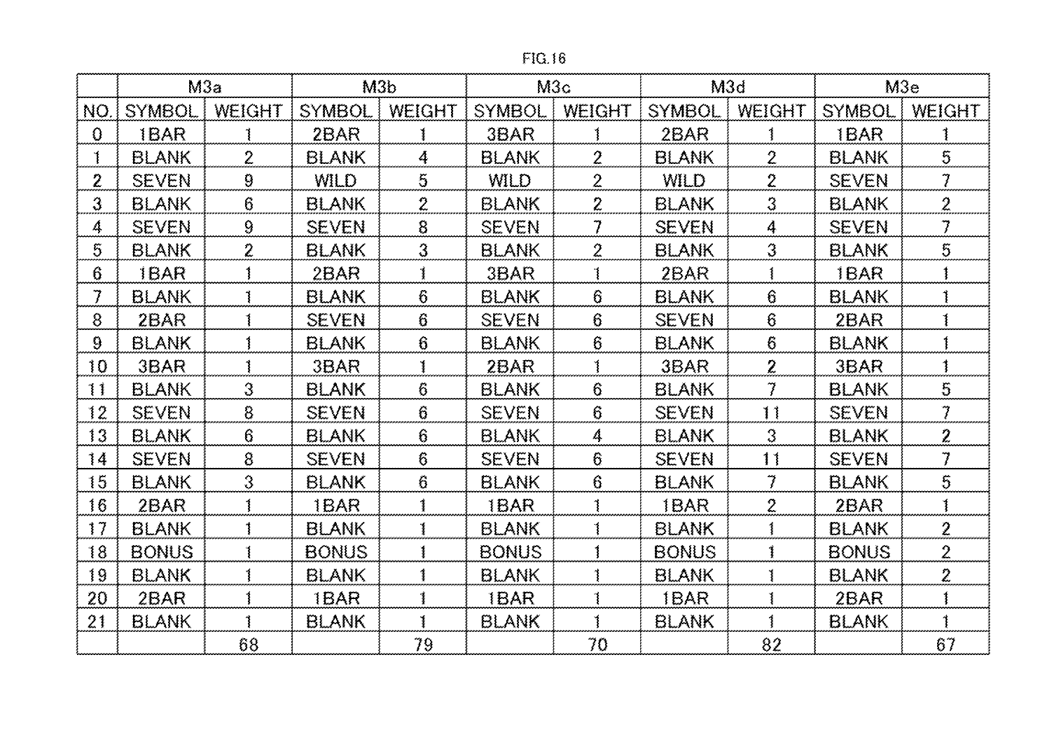

The present embodiment provides two game modes of base game mode and free game mode. The five reel strips to be used are common to these two game modes. As will be described later, the base game mode and the free game mode are provided with different weights for symbol lottery processing. FIG. 15 shows the five reel strips to be used in the base game mode and the weights of the symbols. FIGS. 16 to 18 show the five reel strips to be used in the free game mode and the weights of the symbols.

Thirty paylines are formed in the symbol display area 141d of the gaming machine 1. The thirty paylines do not depend on the bet count and are fixed. That is to say, the thirty paylines are always enabled in each unit game. Accordingly, even if the bet per line is 1, the total bet count is 30; the gaming media corresponding to the bet count are spent.

The gaming machine 1 in the present embodiment has the following kinds of symbols: WILD (wild symbol), RED7, BLUE7, YELLOW7, WHITE7, 3BAR, 2BAR, 1BAR, BONUS (trigger symbol), and BLANK. The colors of the RED7, BLUE7, YELLOW7, and WHITE7 are described later.

The WILD is a symbol to be replaced with another kind of symbol in identifying a winning pattern completed along a payline. To make an advantageous winning pattern, a WILD is replaced with another kind of symbol in identifying a winning pattern. In the present embodiment, WILDs are provided on only three mech reels M3b, M3d, and M3d (see FIGS. 15 to 18).

The BONUS is a scatter symbol. Independently from the paylines, when a predetermined number, for example three, of BONUSes are determined to appear in the symbol display area 141d in symbol lottery processing, a winning pattern is completed. For example, when one BONUS on the mech reel M3a, one BONUS on the mech reel M3d, and one BONUS on the mech reel M3e are determined to appear in the symbol display area 141d, a winning pattern is completed.

Completion of a winning pattern of BONUSes triggers a free game mode. Winning patterns of BONUSes are completed in both of the base game mode and the free game mode. The completion of a winning pattern of BONUSes in a free game mode retriggers the free game mode.

<Determination of color for symbol 7>

In the gaming machine 1 in the present embodiment, a specific kind of symbols, for example 7s, are disposed on the five mech reels M3a to M3e without being colored. That is to say, the outlines of the figures of 7s are drawn on the mech reels M3a to M3e. As will be described later, each of the five mech reels M3a to M3e is provided with a backlight M7 behind thereof. The backlight M7 includes four kinds of LEDs of red LEDs, blue LEDs, yellow LEDs, and white LEDs. The backlight M7 emits one of red, blue, yellow, and white light by lighting one of the four kinds of LEDs to illuminate each of the mech reels M3a to M3e.

When a symbol 7 is illuminated with red light, the gaming machine 1 in the present embodiment regards the symbol 7 as RED7 to identify a winning pattern. Likewise, when the symbol 7 is illuminated with blue light, the gaming machine 1 in the present embodiment regards the symbol 7 as BLUE7 to identify a winning pattern; when the symbol 7 is illuminated with yellow light, the gaming machine 1 in the present embodiment regards the symbol 7 as YELLOW7 to identify a winning pattern; and when the symbol 7 is illuminated with white light, the gaming machine 1 in the present embodiment regards the symbol 7 as WHITE7 to identify a winning pattern.

The outline of determining a color for illuminating a 7 is as follows. The details of the process of determining the color will be described later. First, a color table to be used in a unit game is determined by lottery from a plurality of color tables for each of the five mech reels M3a to M3e (see steps S2615 and S2617 in FIG. 26 and FIGS. 29 to 31). Next, a color is determined for each 7 disposed on each of the five mech reels M3a to M3e using the color table for the reel (see steps S2619 and S2629 in FIG. 26 and FIG. 32). Next, a to-be stopped symbol is determined by lottery for each of the five mech reels M3a to M3e (see step S1919 in FIG. 19).

### <Progressive Jackpots>

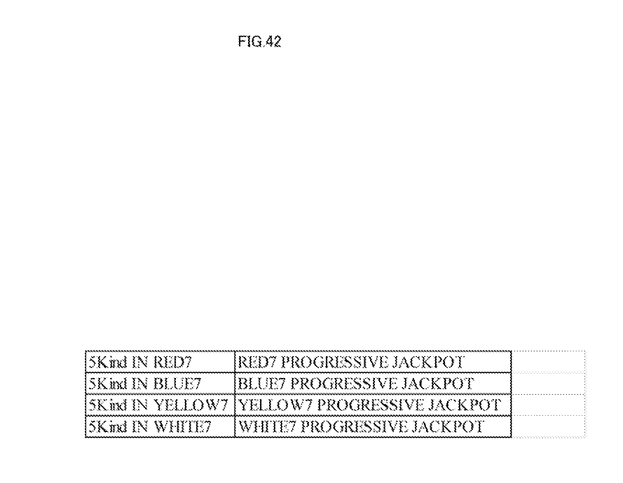

The gaming machine 1 in the present embodiment has four kinds of progressive jackpots (see FIG. 42). When a 5Kind in 7 of a color is completed, the player wins the progressive jackpot associated with the color and is provided with payout. In the gaming machine 1 in the present embodiment, completion of a 5Kind in RED7 results in winning a RED7 progressive jackpot; completion of a 5Kind in BLUE7 results in winning a BLUE7 progressive jackpot; completion of a 5Kind in YELLOW7 results in winning a YELLOW7 progressive jackpot; and completion of a 5Kind in WHITE7 results in winning a WHITE7 progressive jackpot (see FIG. 42). Payouts are defined individually for the colors of red, blue, yellow, and white.

In the gaming machine 1 in the present embodiment, the 5Kind in 7 means that five 7s are arranged along a payline. That is to say, the 5Kind in 7 is a state where at least one 7 appears on each of the five mech reels M3a to M3e and these five 7s are arranged along any one of the paylines.

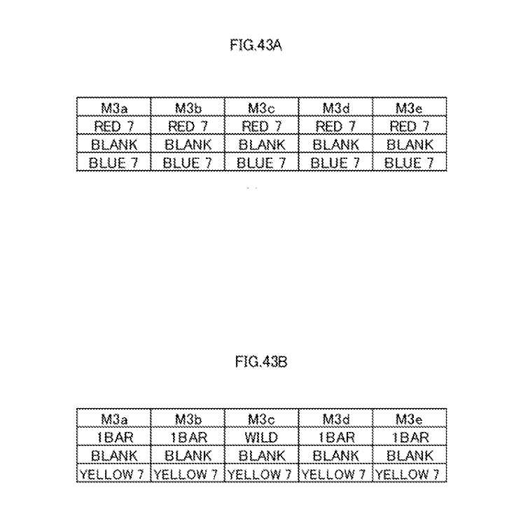

For example, when five RED7s are arranged along the top row of the symbol display area 141d, the RED7 progressive jackpot is won; a payout associated with red is provided (see FIG. 43A). When five BLUE7s are arranged along the bottom row of the symbol display area 141d, the BLUE7 progressive jackpot is won; a payout associated with blue is provided (see FIG. 43A).

When five RED7s are arranged along the top row and concurrently, five BLUE7s are arranged along the bottom row as shown in FIG. 43A, the RED7 progressive jackpot and the BLUE7 progressive jackpot are won; a payout associated with red and a payout associated with blue are provided. Like this case, if two kinds of progressive jackpots are concurrently won on a plurality of paylines, payouts are provided for all the completed paylines.

The gaming machine 1 in the present embodiment provides a payout for the progressive jackpot associated with the color when a WILD appears in the symbol display area 141d to complete a 5Kind in 7 of some color. For example, when five YELLOW7 are arranged along the bottom row of the symbol display area 141d, even though a WILD appears on the top row of the mech reel M3c, the YELLOW progressive jackpot is won and a payout associated with yellow is provided (see FIG. 43B).

The payout to be provided at winning a progressive jackpot depends on the bet count in the play. Increment amounts are not added to the progressive jackpots in the free game mode. Furthermore, the gaming machine 1 in the present embodiment cannot disable the progressive jackpots. The details of the progressive jackpots will be described later.

### <Free Game Mode>

When the condition is satisfied that a winning pattern of BONUSes be completed in a unit game conducted in a base game mode, a free game mode is triggered. When the condition is satisfied that a winning pattern of BONUSes be completed in a unit game conducted in a free game mode, the free game mode is retriggered.

As mentioned above, the BONUSes are scatter symbols. Accordingly, when a predetermined number or more, for example three or more, of BONUSes are determined to appear in the symbol display area 141d through symbol lottery processing, a winning pattern is completed, so that a free game mode is triggered or retriggered. In the gaming machine 1 in the present embodiment, the free game mode is a game mode for conducting a unit game without requiring gaming value to be spent, compared with the base game mode.

Triggering a free game mode results in either case: a case where the game mode changes from a base game mode to a free game mode or a case where a free game mode is maintained (the free game mode is retriggered to continue the free game mode).

At the start of a free game mode, eight unit games are provided. In the free game mode, a game result is determined by lottery processing with weights different from those in the base game mode (see FIGS. 15 to 18).

In the free game mode, a winning pattern of BONUSes can also be completed. That is to say, three or more BONUSes are determined to appear in the symbol display area 141d to complete a winning pattern through symbol lottery processing and to retrigger the free game mode. When the free game mode is retriggered, eight more unit games are added.

In the free game mode, a color is selected for the 7s in each unit game so that all the 7s have the same color. The free game mode uses weights different from those in the base game mode (see FIGS. 15 to 18) to select to-be stopped symbols by lottery. The weights to be used are different depending on the color selected for the 7s. The free game mode takes over the bet count in the base game mode when entering the free game mode. As described above, the increment amounts are not added in the free game mode.

When satisfying the condition that the number of conducted unit games in the free game mode reaches the maximum number, or that no unit game remains, the free game mode is terminated and the game mode returns to the base game mode.

### <<<Overall Configuration of Slot Machine 10>>>

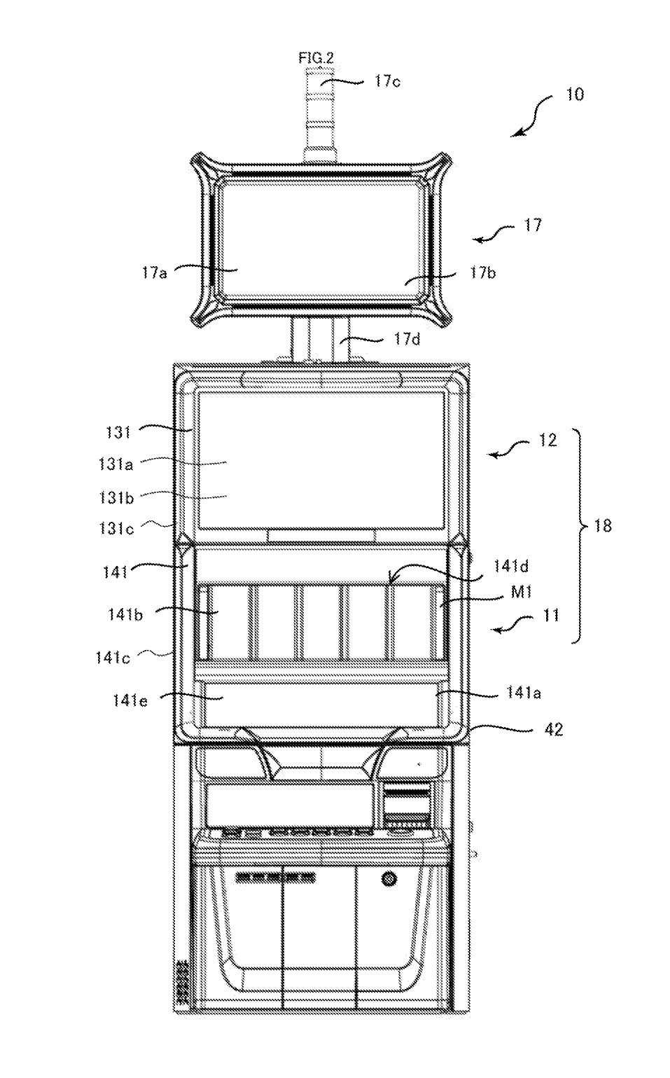

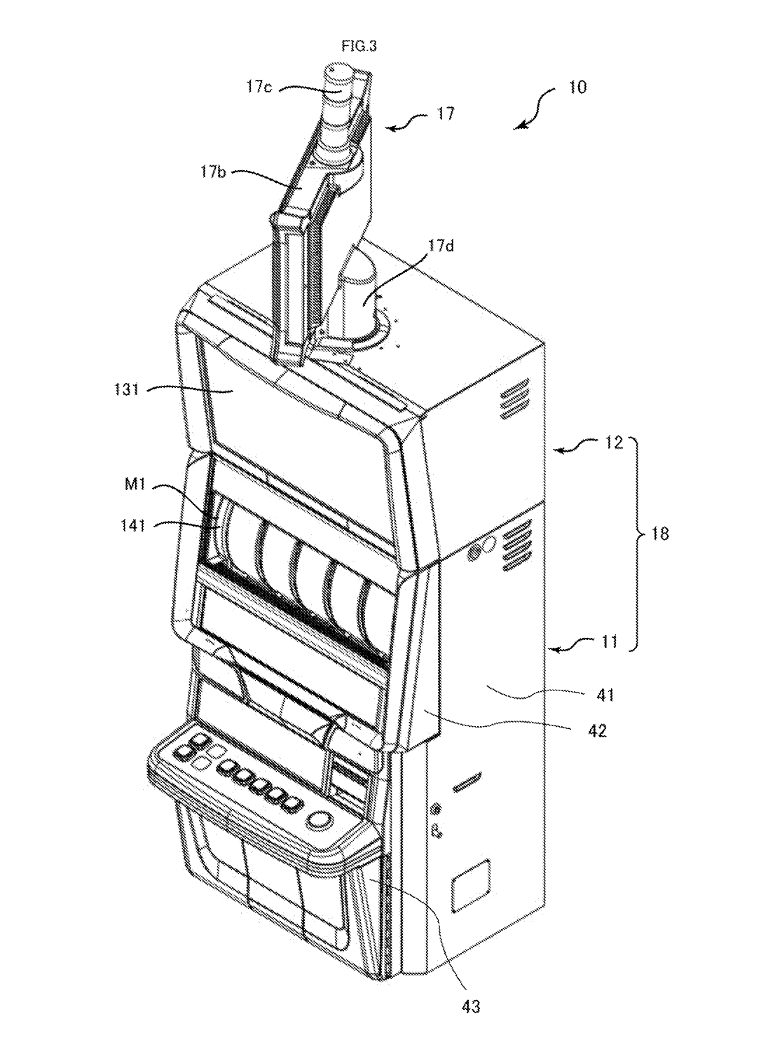

As illustrated in FIGS. 2 and 3, a slot machine 10 as a gaming machine includes a topper unit 17 and a gaming machine main body 18. On the top face of the gaming machine main body 18, the topper unit 17 is mounted. The gaming machine main body 18 includes a top unit 12 and a main unit 11. The top unit 12 includes an upper display unit 131. The top unit 12 is mounted on the top face of the main unit 11. The main unit 11 includes a lower display unit 141.

The topper unit 17 has a function to draw attention to the slot machine 10 from distant places and a function to advertise the games of the slot machine 10 to distant places. The top unit 12 has a function to display the specifics of the games, a payout table, and game-related information such as rules. The main unit 11 has a function to perform the games.

In the present embodiment, the region (direction) of the slot machine 10 facing (toward) the player is referred to as front (forward), the opposite region (direction) to the front (forward) is referred to as back (backward or depth direction), the right and the left as seen from the player are respectively referred to as right (rightward) and left (leftward) of the slot machine 10. The extent between the front and the back is referred to as front-to-back, thickness, or depth; the extent between the right and the left are referred to as left-to-right or width. The extent orthogonal to the front-to-back (thickness or depth) and the left-to-right (width) are referred to as top-to-bottom or height.

### <Outline of Topper Unit 17>

The topper unit 17 is provided on the top face of the top unit 12 to be located at the highest position of the slot machine 10. The topper unit 17 has a rotary shaft standing in the direction of the height of the slot machine 10 and is rotatable within a predetermined angle in a right direction (clockwise direction) and a reverse direction (counterclockwise direction) about this rotary shaft. This structure enables the topper unit 17 to switch its position between the front position (FIG. 2) where the screen 17a for displaying information on the games faces forward and an oblique position (FIG. 3) where the screen 17a faces obliquely forward.

The front position is selected in a normal state when games are being played or the slot machine 10 is standing by to show information on the game to people (players or game hall staff) distant from the slot machine 10. The oblique position is a special position to be selected to change the indication of the topper unit 17. As shown in FIG. 3, by turning the topper unit 17 so that the right end of the topper unit 17 will come forward, the oblique position allows the operation to change the indication of the topper unit 17 from the front of the slot machine 10.

### <Specific Configuration of Topper Unit 17>

As shown in FIGS. 2 and 3, the topper unit 17 includes a topper body 17b including a screen 17a and a tower member 17c provided on the top face of the topper body 17b. The tower member 17c has a cylindrical clear resin cover and has a light emission device like an LED therein. The tower member 17c shines at the top of the slot machine 10 in a single color or multiple colors to easily inform distant people of the place or the state of the slot machine 10.

The topper unit 17 has a topper support device 17d as shown in FIGS. 2 and 3. The topper support device 17d supports the topper body 17b to be horizontally rotatable within a specific angle with respect to the top unit 12.

### <Top Unit 12>

The topper unit 17 structured as described above is provided on the top of the top unit 12 as shown in FIGS. 2 and 3. The top unit 12 includes an upper display unit 131 provided on the front of the top unit 12. On the top face of the top unit 12, the topper body 17b is supported by the topper support device 17d to be horizontally rotatable within a specific angle with respect to the top unit 12.

### <Upper Display Unit 131>

The upper display unit 131 includes an upper touch panel 131a provided on the front, an upper liquid crystal display panel 131b provided behind the upper touch panel 131a, and an upper control board base 131c.

The upper liquid crystal display panel 131b displays motion picture such as a video and image data of still pictures such as characters and figures. The upper touch panel 131a transmits the images shown on the upper liquid crystal display panel 131b for the player to see the images and enables touch operations on the screen with the player's fingertip. The upper control board base 131c includes not-shown control boards for controlling the display of the upper liquid crystal display panel 131b inside thereof.

### <Main Unit 11>

The top unit 12 structured as described above is provided on the top of the main unit 11. The main unit 11 includes a lower display unit 141, an upper door unit 42, and a lower door unit 43 provided under the lower display unit 141 and on the front of the main unit 11. The upper door unit 42 and the lower door unit 43 are openable with respect to a gaming mechanism unit 41. The upper door unit 42 is structured to be allowed to open only when the lower door unit 43 is open.

### <Lower Display Unit 141>

The lower display unit 141 includes a lower touch panel 141a provided on the front, a lower liquid crystal display panel 141b provided behind the lower touch panel 141a, a lower control board base 141c, and a reel unit M1.

The lower liquid crystal display panel 141b shows motion picture such as a video and image data of still pictures such as characters and figures. The lower touch panel 141a transmits the images shown on the upper liquid crystal display panel 141b for the player to see the images and enables touch operations on the screen with the player's fingertip. The lower control board base 141c includes not-shown control boards for controlling the lower touch panel 141a inside thereof.

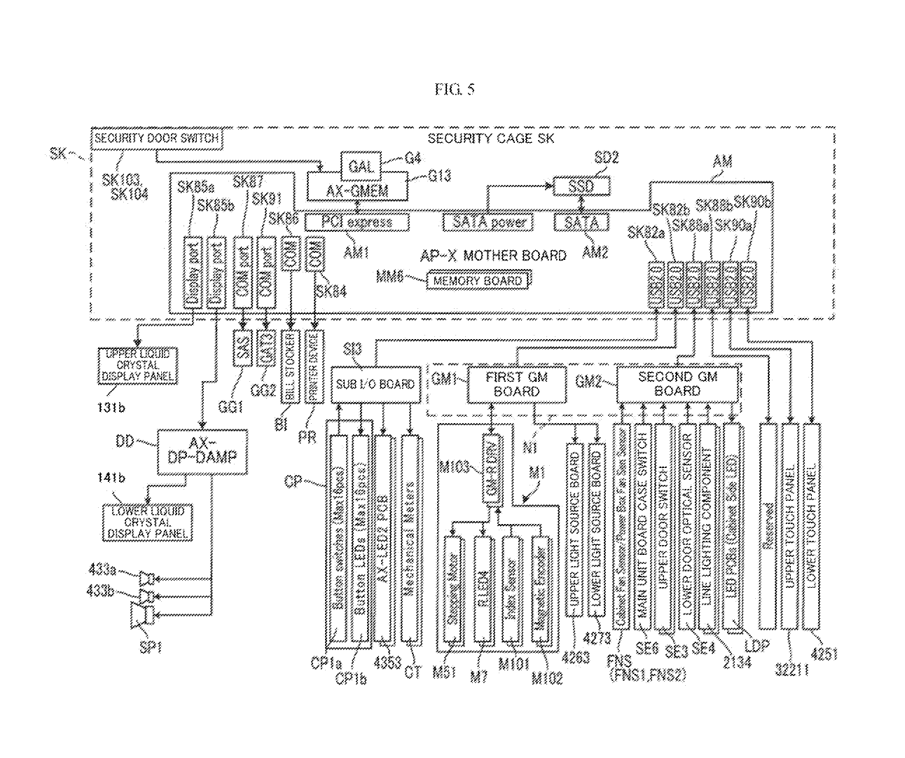

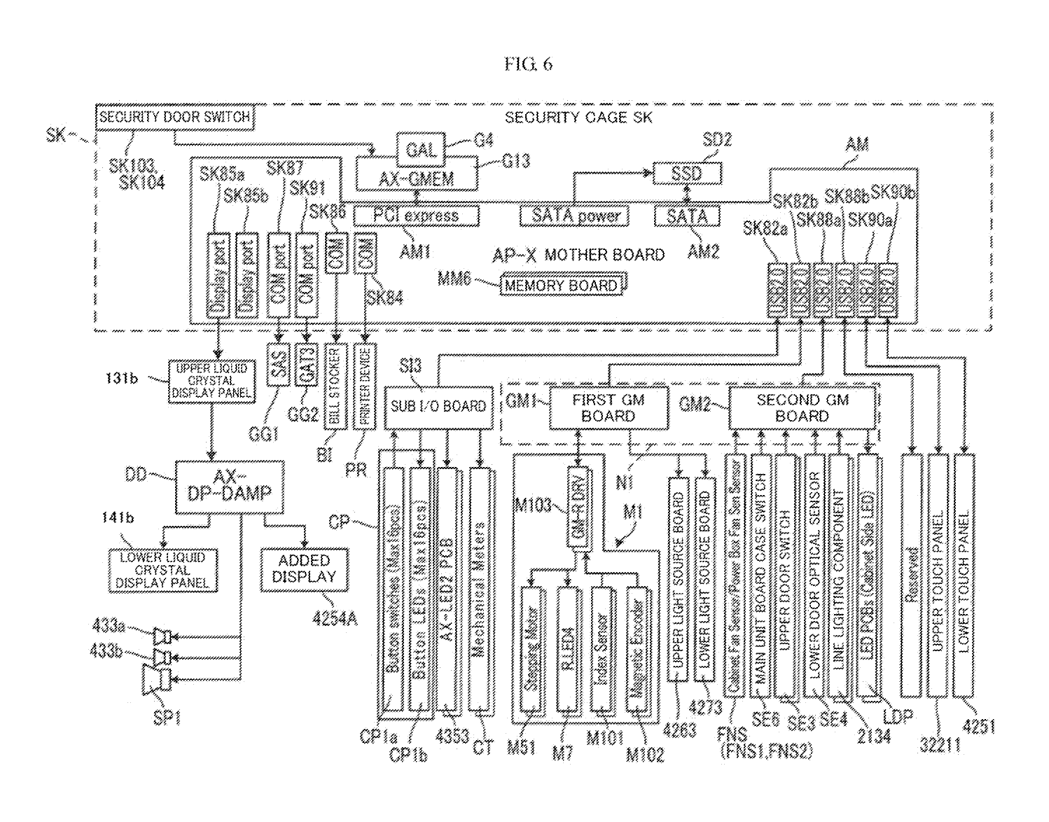

The reel unit M1 includes five rotatable mech reels M3a to M3e. The reel unit M1 further includes stepping motors M51 for spinning and stopping the five mech reels M3a to M3e (see FIGS. 5 and 6). On the outer surface of each of the five mech reels M3a to M3e, a plurality of symbols are disposed in a single line along the longitudinal direction. Each of the five mech reels M3a to M3e can change its spin speed and spin direction with a stepping motor M51.

The reel unit M1 spins and then stops the five mech reels M3a to M3e with the stepping motors M51. These operations make symbols disposed on the five mech reels M3a to M3e move and stop in the symbol display area 141d. Stopping symbols in the symbol display area 141d rearranges symbols in the symbol display area 141d.

In the present embodiment, three rows of a top row, a middle row, and a bottom row are defined as stop positions in the symbol display area 141d for the symbols on the mech reels M3a to M3e. Accordingly, when the five mech reels M3a to M3e (five reel strips) are stopped, 5 by 3 (5 columns by 3 rows) of 15 symbols in total appear (are stopped) in the symbol display area 141d. The five mech reels M3a to M3e start spinning (being shuffled) upon start of a unit game. After a predetermined time, the five mech reels M3a to M3e stop. As a result, 15 symbols appear (are stopped) in the symbol display area 141d and the symbols are rearranged. That is to say, each time a unit game is conducted, symbols are rearranged in the symbol display area 141d to show a result of the unit game. In the present embodiment, the 5 by 3 (5 columns by 3 rows) of 15 symbols rearranged in the symbol display area 141d form a symbol matrix.

The speeds and the directions in the shuffling of the five mech reels M3a to M3e can be determined individually depending on the game mode and the unit game.

The symbol display area 141d has symmetric payline generation columns on the left end and the right end thereof. The payline generation column on the left end provided on the left as seen from the player has 30 payline generators. The payline generation column on the right end provided on the right as seen from the player has 30 payline generators.

Each payline generator on the left end is paired with one of the payline generators on the right end and a payline starting from the payline generator on the left end to the paired payline generator on the right end is predefined. Thirty paylines are defined in the present embodiment.

In the present embodiment, the 30 paylines are always enabled. The number of paylines to be enabled may be determined based on the amount of bet. In the case of MAX BET or the maximum amount of bet, the full 30 paylines are enabled. The enabled paylines generate winning patterns of each kind of symbols. The details of the winning patterns are described later.

Although the present embodiment describes a slot machine 10 that displays symbols with the mech reels M3a to M3e, the slot machine 10 may display symbols by using a video reel system and a mech reel system together.

The lower display unit 141 has a game status indication area 141e under the symbol display area 141d. The game status indication area 141e indicates a variety of information on games such as a status of credits and details of bet.

### <Control Panel CP>

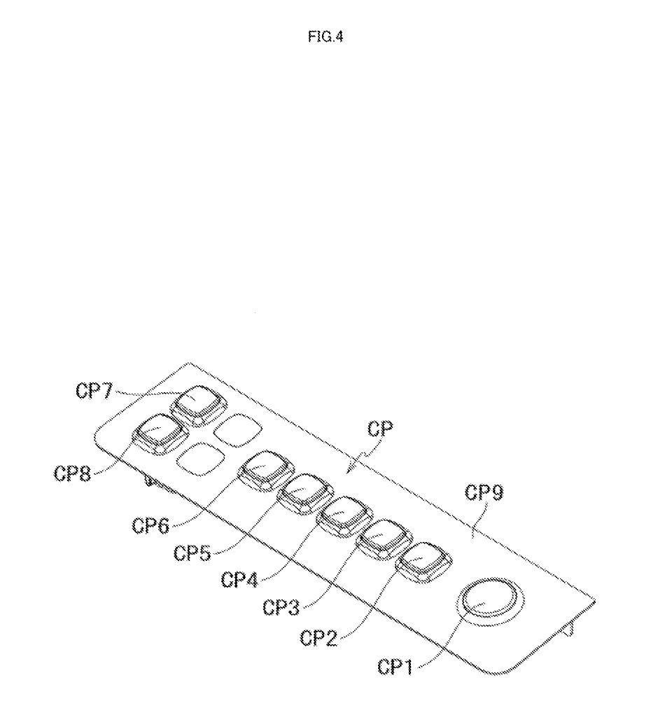

The slot machine 10 has a control panel CP. As shown in FIG. 4, the control panel CP includes a planar base plate CP9 and a plurality of operation buttons CP1 to CP8 provided on the base plate CP9. The operation button CP1 has a circular shape that is larger than the other buttons CP2 to CP8 so that the player can easily press it and easily distinguish it from the other buttons. The operation button CP1 is disposed on the rightmost area of the base plate CP9 and functions as a start button or spin button to start a game in response to a press operation.

The operation buttons CP2, CP3, CP4, CP5, and CP6 are disposed in a line at equal intervals on the left of the operation button CP1. These operation buttons CP2 to CP6 have square shapes. The rightmost operation button CP2 functions as a MAX BET button for a game to bet maximally, for example ten units of gaming value, in response to a press operation. The operation button CP3 functions as a 5BET button for a game to bet five units of gaming value in response to a press operation. The operation button CP4 functions as a 3BET button for a game to bet three units of gaming value in response to a press operation. The operation button CP5 functions as a 2BET button for a game to bet two units of gaming value in response to a press operation. The operation button CP6 functions as a 1BET button for a game to bet one unit of gaming value in response to a press operation.

The operation buttons CP7 and CP8 are disposed at the front and the back on the leftmost area of the base plate CP9. The operation button CP7 functions as a HELP button to indicate help information such as how to play games in the game status indication area 141e in response to a press operation. The operation button CP8 functions as a cashout button to return the credit by way of coins and printed information in response to a press operation.

### <Overall Configuration of Game System>

A game system 600 including slot machines 10 having the above-described functions is described.

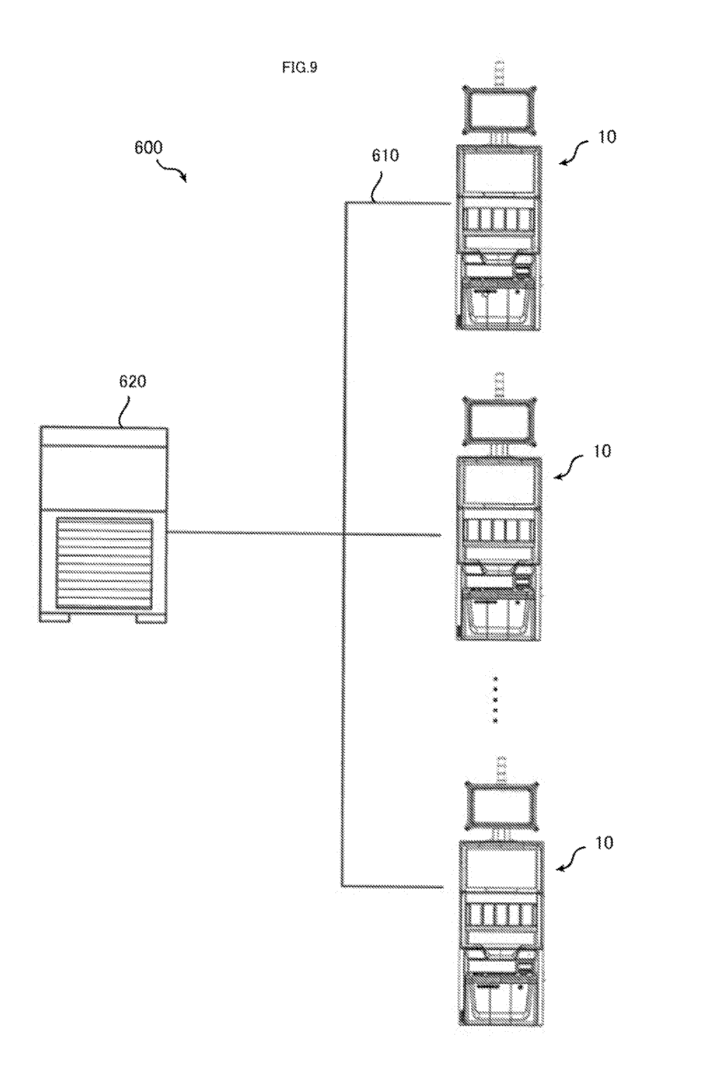

As illustrated in FIG. 9, a game system 600 includes a plurality of slot machines 10 and an external control device 620 connected with the slot machines 10 through a communication line 610.

The external control device 620 is to control the plurality of slot machines 10. In the present embodiment, the external control device 620 is a so-called hall server installed in a game hall having the plurality of slot machines 10. Each of the slot machines 10 is assigned a unique identification number; the external control device 620 identifies a slot machine 10 that sends data to the external control device 620 with the identification number. Furthermore, the external control device 620 uses the identification numbers to designate a destination in sending data to a slot machine 10.

The game system 600 may be constructed within a single game hall where various games can be conducted, such as a casino, or may be constructed among a plurality of game halls. In the case where the game system 600 is constructed in a single game hall, the game system 600 may be constructed on each floor or in each section of the game hall. The communication line 610 may be wired or wireless, and can adopt a dedicated line, an exchange line, or the like.

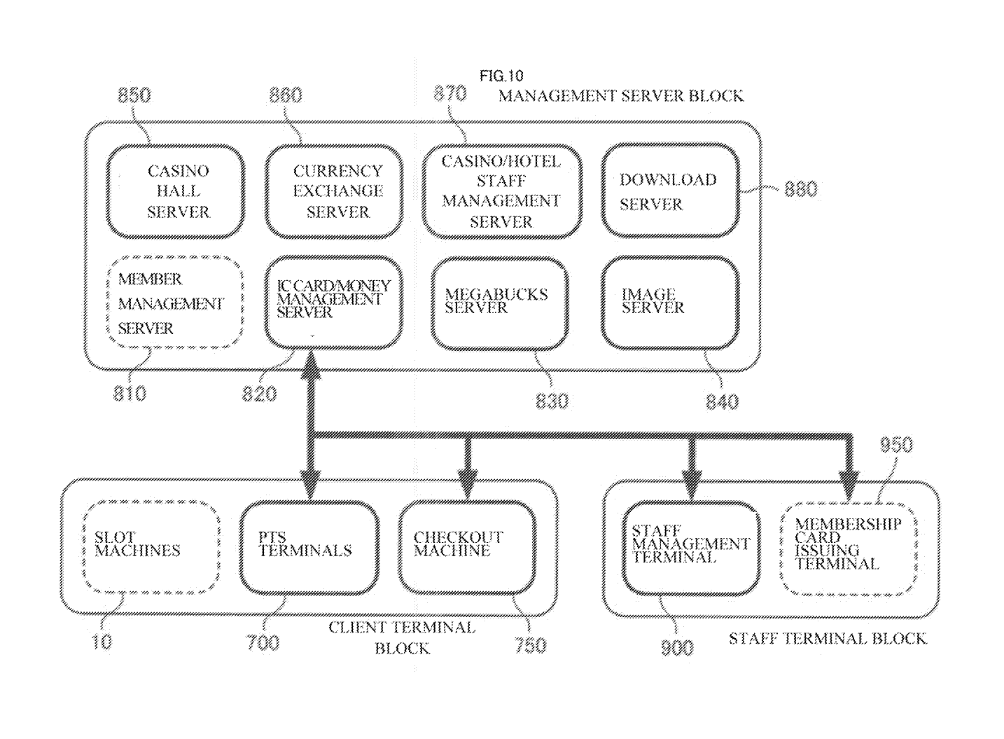

As illustrated in FIG. 10, the game system is generally grouped into the following three blocks: a management server block, a client terminal block, and a staff terminal block. The management server block includes a casino hall server 850, a currency exchange server 860, a casino/hotel staff management server 870 and a download server 880.

The casino hall server 850 is a server for managing the entire casino hall where the slot machines 10 are installed. The currency exchange server 860 is a server for generating exchange rate data based on currency exchange information. The casino/hotel staff management server 870 is a server for managing the staff working in the casino hall and/or a hotel related to the casino hall. The download server 880 is a server for downloading latest information such as information on the games and news and for notifying the players of the information through the PTS terminals 700 of the slot machines 10.

The management server block further include a member management server 810, an IC card/money management server 820, a megabucks server 830, and an image server 840.

The member management server 810 is a server for managing membership information on the players of the slot machines 10. The IC card/money management server 820 is a server for managing IC cards to be used in the slot machines 10. Specifically, the IC card/money management server 820 stores data on fractional amount of cash in association with an identification code and outputs the data on fractional amount of cash to a PTS terminal 700. The IC card/money management server 820 further generates and manages denomination rate data. The megabucks server 830 is a server for managing a megabucks, which is a kind of game that provides the total amount of bet of a plurality of slot machines 10 installed in a plurality of casino halls for an award. The image server 840 is a server for downloading latest images about the game and news and for notifying the players of the images through the PTS terminals 700 of the slot machines 10.

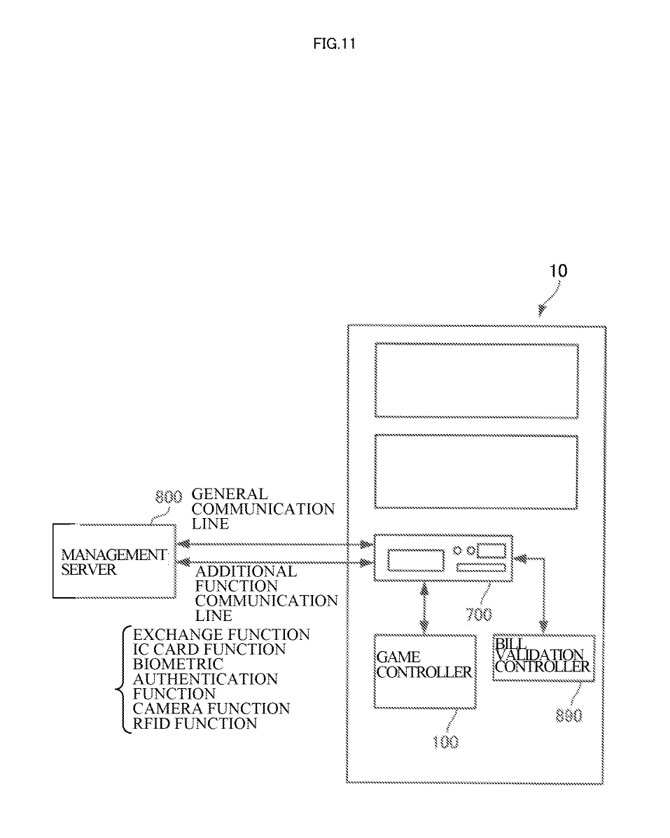

A client terminal block includes slot machines 10, PTS terminals 700, and a checkout machine 750. The PTS terminals 700 are attachable to the slot machines 10 and can interactively communicate with the management server 800 (see FIG. 11). The checkout machine 750 is a machine for a player to checkout by converting the money data stored in the player's IC card into cash or to store money data indicating the amount of coins or a bill in the IC card.

A staff terminal block includes a staff management terminal 900 and a membership card issuing terminal 950. The staff management terminal 900 is a terminal for the staff of the casino hall to manage the slot machines 10. Particularly in the present embodiment, the staff of the casino hall manages whether the PTS terminals 700 hold too many IC cards or are in short of IC cards. The membership card issuing terminal 950 is a terminal to be used to issue a membership card for a game player in the casino hall.

### <PTS Terminal 700>

The PTS terminals 700 are included in a PTS system as illustrated in FIG. 11. A PTS terminal 700 attached to a slot machine 10 is connected with the game controller 100 and the bill validation controller 890 of the slot machine 10 to be able to communicate with each other.

The PTS terminal 700 coordinates game effects of sound and images and updates credit data through communications with the game controller 100. The PTS terminal 700 sends credit data required for checkout through communications with the bill validation controller 890.

The PTS terminal 700 is also connected with the management server 800 to be able to communicate with each other. The PTS terminal 700 communicates with the management server 800 using two communication lines: a general communication line and an additional function communication line.

The PTS terminal 700 uses the general communication line to communicate data such as money data, identification code data, and player's membership information. The PTS terminal 700 uses the additional function communication line for communications related to newly added functions. The PTS terminal 700 in the present embodiment uses the additional function communication line for communications related to the exchange function, the IC card function, the biometric authentication function, the camera function, and the RFID (radio frequency identification) function, which is a function for identifying objects using radio wave.

### <Electrical Configuration of Slot Machine 10>

Next, the electrical configuration of the slot machine 10 is described. As illustrated in FIG. 5, the slot machine 10 employs a CPU having GPU (Graphics Processing Unit) functionality to eliminate a graphic board, which prevents unauthorized tampering through PCI Express and achieves lower power consumption and lower heating. In other words, the slot machine 10 is a gaming machine employing a CPU with integrated GPU and is configured with a motherboard including the CPU with an integrated GPU (on a single die), a PCI Express expansion slot AM1 connected with a GAL board G4 holding an authentication program, and DisplayPort connectors SK85a and SK85b connected with the GPU.

This configuration eliminates a graphic board from being connected with the PCI Express expansion slot AM1; the slot machine 10 can use the expansion slot AM1 as a dedicated terminal for authentication. The distinct looks of the dedicated connection enables the security monitoring to be easier. Furthermore, the slot machine 10 can eliminate the possible problems caused by connecting a graphic board to the PCI Express expansion slot AM1, such as unsmoothness in outputting video signals or audio signals because of an interruption to or from another board and a collision of interruptions because of the relation with another board. In addition, the slot machine 10 can use the DisplayPort connectors SK85 as dedicated terminals for video (audio) to prevent interferences with other boards. As a result, video (audio) signals can be output smoothly to be synchronized accurately with the game process.

The slot machine 10 is equipped with a motherboard having a CPU with a built-in graphics engine for implementing the GPU functionality, which lowers the possibility that a video is suspended during a game. Using the motherboard having a CPU with a built-in graphics engine, the slot machine 10 outputs video data for video effects from the graphics engine controlled by the CPU to a sub board and outputs audio signal to a sub board from the CPU. In this configuration, video data and audio data is output from the motherboard in accordance with the control of a single CPU with a built-in graphics engine; accordingly, unless the CPU malfunctions, the slot machine 10 can prevent an accident of outputting only one of the video and audio to a sub board and making the effects unclear.

The slot machine 10 may be configured to perform the followings: connecting a security board (GAL board G4) having a flash RAM holding different sizes of startup-related data such as a boot BIOS and a public key to be used to start up the slot machine 10 to the motherboard via PCI Express, detecting the size of startup-related data, transferring the startup-related data to the DRAM on the motherboard at a transfer rate suitable for the data size, and executing startup processing based on the startup-related data with the DRAM. PCI Express allows software to dynamically change transfer rate; accordingly, this configuration enables power saving when the highest speed is not necessary. Even if update of the data of the boot BIOS significantly changes the data size on the security board, the slot machine 10 can automatically set an optimum time to start up and an optimum power to be consumed.

The slot machine 10 may further be configured to detect a rise in temperature of the security board caused by transferring data and to control the transfer rate of the startup-related data based on the rise in temperature in the foregoing operations of connecting a security board having a flash RAM holding different sizes of startup-related data such as a boot BIOS and a public key to be used to start up the slot machine 10 to the motherboard via PCI Express, transferring the startup-related data to the DRAM on the motherboard, and performing startup processing based on the startup-related data with the DRAM. The rise in temperature of the security board is supposed to be proportional to the power consumption; accordingly, controlling the transfer rate so as to keep the temperature constant enables startup processing to be performed at a transfer rate with stable power consumption.

The slot machine 10 is a gaming machine that uses an SSD (SSD board SD2) holding an OS (Operating System); the slot machine 10 is equipped with an AP-X motherboard AM including a CPU and a SATA terminal (SATA board-to-board connector AM2) and an SSD connected with the SATA terminal. By connecting to the SSD via the SATA terminal and booting the OS from the SSD, the slot machine 10 eliminates the problems caused by booting the OS from a flash memory like an SD card, for example, problems that a conversion adapter is required, that the operation frequently becomes unstable, and that the SD card is expensive. When booting the OS from a flash memory like an SD card, the flash memory needs to be recognized at the BIOS level, which does not allow some motherboards to boot the OS. However, when an SSD is used to boot the OS, the OS can be booted properly and speedily; the versatility is enhanced and programs for the gaming machine can be start up instantly.

The slot machine 10 is capable of triple display output with the motherboard having two DisplayPort terminals and a DVI output. This configuration enables high speed and large screen display and eliminates the license cost, compared to using HDMI™. The slot machine 10 further includes a DP D-AMP board DD (DisplayPort audio amplifier board) for retrieving an audio signal from DisplayPort, and amplifying and outputting the audio signal.

The slot machine 10 outputs video data and audio data during games using DisplayPort by packets to produce video and audio effects with the devices for implementing the effects. Since the video data and the audio data are output to a DisplayPort signal line, the slot machine 10 can eliminate losing either one of the video data and the audio data. As a result, the slot machine 10 does not fail in sufficiently informing the player of a lottery result because of outputting only one of the video and the audio indicating a lottery result. Furthermore, this configuration allows a plurality of displays to be connected in series; accordingly, adding a display can be made easily, which facilitates design change based on the existing slot machine 10. For example, in adding a display device to the top unit 12 in addition to the upper liquid crystal display panel 131b and the lower liquid crystal display panel 141b, only connecting a signal line from the upper liquid crystal display panel 131b to the display device of the top unit 12 completes the mechanical signal line connection; in addition, easy maintenance of the display device can be attained. In the meanwhile, data transmission by packets does not require data transmission to the plurality of display devices one by one; programs can be modified easily.

The specific electrical configuration of the slot machine 10 is described. The slot machine 10 has an AP-X motherboard AM enclosed in a security cage SK. The AP-X motherboard AM includes a not-shown 4th Generation Intel® Core™ processor, so that the power management function (C state) in idling is improved. Further, a VR (voltage regulator) is integrated within the package/die of the processor to simplify the power design in the entire platform, so that low power consumption is achieved inclusive of the motherboard. The 4th Generation Intel® Core™ processor has 20 EUs (Execution Units) as graphics execution units in a GPU core. Accordingly, compared to the 3rd Generation Intel® Core™ processor, significant performance improvement has been achieved. The 4th Generation core i-series chipset has multiple ports for SATA 6 Gb/s (SATA 3.0) of a high-speed interface and supports PCI Express 3.0 for smooth data transfer to a high-performance video card and DDR3-1600 of a high-speed memory specification.

The AP-X motherboard AM has a PCI Express expansion slot AM1, a SATA board-to-board connector AM2, a first and a second DisplayPort connectors SK85a and SK85b, a first and a second LAN jacks SK87 and SK91, a first and a second D-sub connectors SK86 and SK84, a first to a sixth USB connectors SK82a, SK82b, SK88a, SK88b, SK90a, and SK90b.

PCI (Peripheral Component Interconnect) Express is a serial transfer interface for computers that supersedes PCI. PCI Express is not physically compatible with PCI employing parallel transfer; however, PCI Express uses the same communication protocol as PCI. The smallest unit of transmission channel (called lane) used in PCI Express is capable of full duplex communications at 2.5 Gbps in simplex and at 5.0 Gbps in duplex. The effective data transfer rate is 2.0 Gbps (250 MB/s) in simplex and 4.0 Gbps (500 MB/s) in duplex because transmitting 8-bit data requires 10 bits in which 2 bits of a clock signal and other data are added. The expansion slot AM1 of the AP-X motherboard AM is a PCI Express port containing multiple lanes.

SATA (Serial AT Attachment) is an expansion of IDE (ATA) standard for connecting a computer with a storage device such as a hard disk drive or an optical drive. SATA has been developed by changing the parallel transfer employed in the ATA specifications into serial transfer, achieving high transfer rate with a simple cable.

DisplayPort is a full digital video interface and employs micro packet system utilizing embedded clocks. The micro packet system can transfer secondary digital audio data in addition to the primary video data; the system encapsulates pixel data and audio signal in a packet called micro packet. That is to say, the micro packet system divides all the video and audio into micro packets called Transfer Units and serially transfers the Transfer Units to the destination devices.

DisplayPort generates a clock from data without using an external clock signal; accordingly, speedy data transfer and feature expansion is easily available. Furthermore, since DisplayPort is a video output interface designed for digital display devices, using a liquid crystal display as a display device reduces the number of components and attains a transmission distance of approximately 15 meters.

DisplayPort defines the output side as source device and the input side as sink device. The source device and the sink device communicate with each other to automatically optimize the resolution, color depth, refresh rate, and the like. Transmission rate of video and audio data can be changed using the combinations of one, two, and four channels called lanes and two data rates of 1.62 Gbps and 2.7 Gbps. For example, the lowest rate is obtained in the configuration of one lane at 1.62 Gbps and the highest rate is 10.8 Gbps obtained in the configuration of four lanes at 2.7 Gbps. The main data channel in DisplayPort can be configured with one, two, or four high-speed SerDes lanes and the bandwidth of 2.7 Gbps or 1.62 Gbps for each lane.

DisplayPort includes an HPD (Hot Plug Detect) signal. Hot Plug Detect is used not only to check whether a display device is connected but also to establish a link. Hot Plug Detect includes a process to inform the sender of establishing a link through a process called link training; during this process, both of the sender and the receiver check whether all the four lanes are necessary. DisplayPort further has an AUX (auxiliary) channel. The AUX channel is a low-speed “side channel” and is a communication channel for managing the link in accordance with the sender's information and controlling the status and configuration. The AUX channel enables bidirectional video and audio communications.

DisplayPort does not have limitation in using multiple screens or display devices from a single digital output port or in display application and brings out the full performance of the displays with zero latency. DisplayPort is featured by Plug and Play; the user does not need to reconfigure the system manually. For example, to add a display device without using DisplayPort, a graphics card or a multi-head graphics card having a plurality of output ports needs to be added. These cards increase the power consumption and the adding the card requires complex work. Using DisplayPort eliminates these problems. As a result, DisplayPort enables addition of a display device without opening the highly confidential security cage SK of the slot machine 10.

DisplayPort can simultaneously transmit a plurality of types of data such as audio, video stream, and the like by employing the micro packet system; accordingly, a plurality of video and audio packets can be transmitted on the same cable. As a result, DisplayPort achieves utilization of picture-in-picture or a plurality of daisy-chained display devices at a link speed as fast as the hub connection with a single connection.

The daisy chain connection is a connection topology in which, among display devices having an input port and an output port of DisplayPort, the output port of the source is connected to the input port of the next display device (sink) on a single link, and regarding the sink display device as a next source, the output port of the display device is connected to the input port of the next display device (sink). In contrast, the hub connection is a connection topology in which one input port is provided with a plurality of output ports and these output ports are connected to the input ports of a plurality of display devices.

The expansion slot AM1 is connected with the AX-GMEM board G13 to be able to transmit data unidirectionally. The AX-GMEM board G13 is connected with a GAL board G4 to be able to transmit data bidirectionally to perform self-authentication of the boot BIOS with the GAL board G4. The details of the boot BIOS self-authentication are described later. The AX-GMEM board G13 is also connected with a first detection sensor SK103 and a second detection sensor SK104 for functioning as security door switches; the open/closure of the security cage door SK3 (not shown) is monitored based on the detection signals from these detection sensors SK103 and SK104.

The SATA board-to-board connector AM2 is connected with an SSD board SD2 to be able to transmit data bidirectionally. The first DisplayPort connector SK85a is connected with the upper liquid crystal display panel 131b to be able to transmit data unidirectionally. The second DisplayPort connector SK85b is connected with the DP D-AMP board DD to be able to transmit data unidirectionally. The DP D-AMP board DD is an audio amplifier board for DisplayPort and is connected with the lower liquid crystal display panel 141b and a speaker (not shown) to be able to transmit data unidirectionally.

The first LAN jack SK87 is a SAS (Serial Attached SCSI) interface and is provided for data communication with a PTS device GG1 having a SAS interface. SAS is an interface standard that has attained serial transmission in the SCSI standard. The second LAN jack SK91 is provided for data communication with a checking information processing device GG2 called GAT3. The first D-sub connector SK86 is connected with a bill stocker BI to be able to transmit data unidirectionally. The second D-sub connector SK84 is connected with a printer device PR to be able to transmit data unidirectionally.

The first USB connector SK82a is connected with a sub I/O board SI3 to be able to receive data unidirectionally. The sub I/O board SI3 is connected with up to 16 button switches CP1a on the control panel CP and button LEDs CP1b. The sub I/O board SI3 is also connected with light emission boards 4353 and counter devices CT.

The second USB connector SK82b is connected with a first GM board GM1 to be able to receive data unidirectionally. The first GM board GM1 is connected with an upper light source board 4263 and a lower light source board 4273.

The third USB connector SK88a is connected with a second GM board GM2 to be able to receive data unidirectionally. The second GM board GM2 is connected with a cabinet fan sensor FNS2 and a power box fan sensor FNS1. The fan sensors FNS output fan temperature signals indicating the temperatures of these fans. The second GM board GM2 is also connected with a main unit board case switch SE6, upper door switches SE3, a lower door optical sensor SE4, and line lighting components 2134, as well as LED boards LDP for driving the line lighting components 2134 and illumination devices (not shown).

The fourth USB connector SK88b is used as a spare. The fifth USB connector SK90a is connected with the upper touch panel 32211 (131a) to be able to transmit data bidirectionally. The sixth USB connector SK90b is connected with the lower touch panel 4251 (141a) to be able to transmit data bidirectionally.

The AP-X motherboard AM has memory boards MM6 including DDR3 memories. The memory boards MM6 is used for OS authentication with the SSD board SD2 and other processing. The details of the OS authentication are described later.

The SSD enables the slot machine 10 to have a long life. The SSD includes a flash memory holding programs for activating and operating the slot machine 10. The slot machine 10 transfers the programs retrieved from the SSD to the DRAM on the motherboard and executes the programs on the DRAM to activate and operate the gaming machine.

Unlike an HDD, an SSD does not have a driving mechanism to spin a disk such as a bearing and a motor. For this reason, the above-described configuration considerably eliminates mechanical failures such as wear in the driving mechanism. Usually, when an SSD repeats rewrite and erasure, an oxide film acting as an insulator of the memory element of the flash memory is deteriorated by electrons. In the above-described configuration, however, most of the accesses to the SSD are to read a program. Accordingly, the deterioration of the memory element can be kept smaller than in the case of accesses including rewrite or erasure to the flash memory. For this reason, the slot machine 10 can use the SSD for a long time without wear of the memory element like in the case of accessing an HDD. As a result, the probability of occurrence of troubles, such as interruption of video or audio effects during a game, can be lowered compared with the configuration including an HDD. The SSD provides a longer life to the gaming machine.

Furthermore, the SSD enables the slot machine 10 to prevent a failure in the middle of a game. The slot machine 10 is equipped with an SSD including a flash memory holding programs for activating and operating the slot machine 10, grasps the count of write to and erasure from the SSD at predetermined intervals, such as a time of startup, and issues a request for replacement of the SSD when the count of write and erasure reaches a threshold for a failure of the memory element.

In the above-described configuration, the SSD is frequently written with some data such as startup information and data read records even if the data saving is not intentional. Accordingly, even if the SSD is used only for read accesses, the memory element is deteriorated by the use. When the gaming machine is used for a long time, the deterioration of the memory element reaches the level to be failed easily. For this reason, the slot machine 10 configured as described above issues a request for replacement of the SSD when the count of write and erasure reaches a threshold for a failure of the memory element, so that a failure in the middle of a game can be prevented.

In the present embodiment, one DisplayPort connector SK85a is connected with the upper liquid crystal display panel 131b and the other DisplayPort connector SK85b is connected with the lower liquid crystal display panel 141b via the DP D-AMP board DD to individually control the plurality of displays with the plurality of DisplayPort terminals. However, the configuration is not limited to this; a plurality of displays may be controlled with a single DisplayPort terminal.

For example, as illustrated in FIG. 6, the upper liquid crystal display panel 131b having input and output ports of DisplayPort may be daisy chained with the lower liquid crystal display panel 141b by connecting the output port of DisplayPort of the upper liquid crystal display panel 131b to the DP D-AMP board DD. Alternatively, the lower liquid crystal display panel 141b having an output port of DisplayPort may be connected with the upper liquid crystal display panel 131b. Furthermore, in adding a display, the display to be added may be connected to the output port of the upper liquid crystal display panel 131b or the lower liquid crystal display panel 141b.

### <AP-X Motherboard AM>

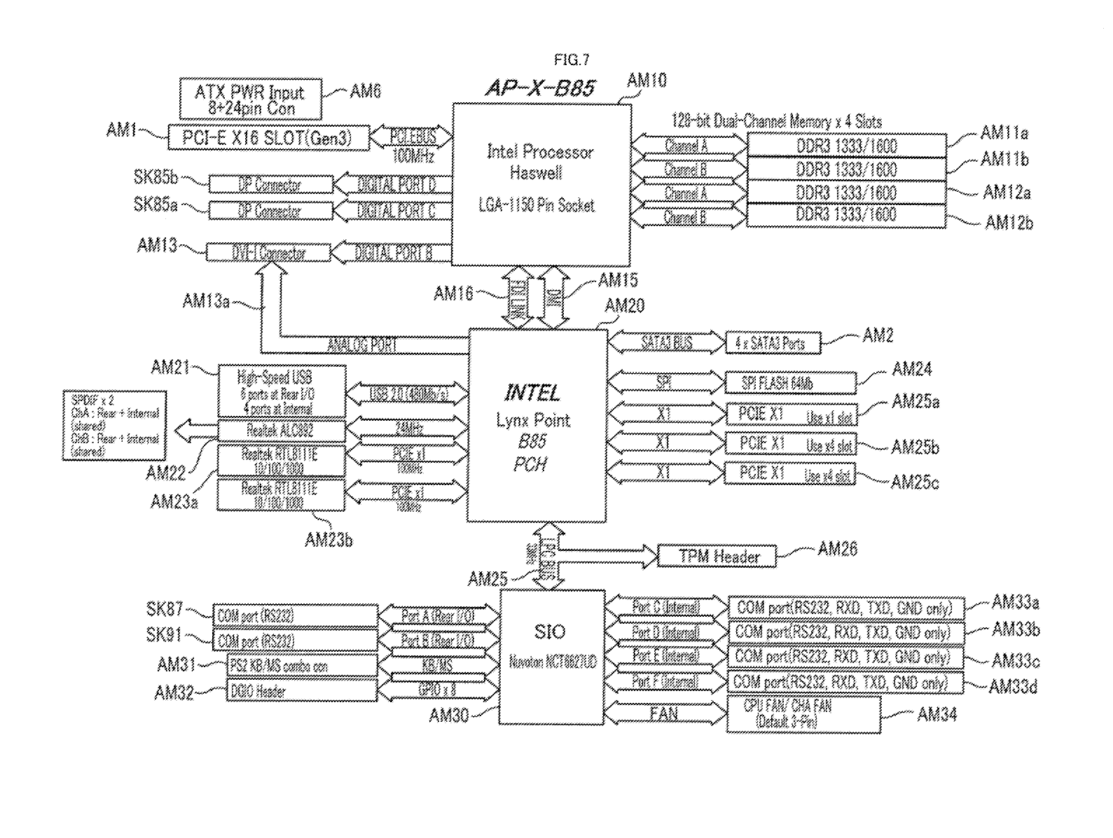

Next, the electrical configuration of the AP-X motherboard AM is described. As illustrated in FIG. 7, the AP-X motherboard AM includes a 4th Generation Intel® Core™ processor (Haswell) AM10, which has 20 EUs as graphics execution units in a GPU core. The processor AM10 is mounted on an Intel LGA 1150 CPU socket and connected with an expansion slot AM1 supporting PCIe (Gen3) x16 specifications (see FIG. 5) to be able to bidirectionally transmit data via a PCIe bus (100 MHz). The AP-X motherboard AM is supplied with power through an 8-pin and 24-pin connector AM6.

The processor AM10 is also connected with four memory slots of slots AM11a and AM12a for Channel A and slots AM11b and AM12b for Channel B to operate in 128-bit dual-channel mode. Each memory slot is occupied by a DDR3 SRAM of a DDR3-1333 or a DDR3-1600. The processor AM10 is further connected with DP (DisplayPort) connectors SK85a and SK85b to be able to unidirectionally transmit data via digital ports C and D. The processor AM10 is still further connected with a DVI-I connector AM13 capable of transmitting both analog and digital video signals to be able to unidirectionally transmit data via a digital port B.

The AP-X motherboard AM also includes a PCH (Lynx Point B85) AM20 of an Intel chipset. The PCH chipset AM20 is a platform controller hub in which the functions of a north bridge (MCH) to connect to the memories and graphics chips and the functions of a south bridge (ICH) to provide interfaces such as PCIe and SATA slots are integrated. The PCH chipset AM20 and the processor AM10 are connected by both of a DMI (Direct Media Interface) bus AM15 and an FDI (Flexible Display Interface) bus AM16 to be able to transmit data bidirectionally.

The PCH chipset AM20 is connected with a plurality of high-speed USB ports AM21 by USB 2.0 with a transfer rate of 480 Mb/s to be able to transmit data bidirectionally. Six of the high-speed USB ports are shown in FIG. 5 as the USB connectors SK82a, SK82b, SK88a, SK88b, SK90a, and SK90b.

The PCH chipset AM20 is also connected with an audio codec chip (Realtek ALC892) AM22 to be able to bidirectionally transmit data at 24 MHz. The audio codec chip AM 22 is connected with two SPDIF channels ChA and ChB. SPDIF is a standard for transferring digital audio signals in video or audio equipment. The PCH chipset AM20 is further connected with two network controller chips (Realtek RTL8111E 10/100/1000) AM23a and AM23b to be able to bidirectionally transmit data at 100 MHz. Furthermore, the PCH chipset AM20 is connected with the DVI-I connector AM13 to be able to unidirectionally transmit data via an analog port AM13a.

The PCH chipset AM20 is connected with four SATA 3 ports AM2 (not shown) to be able to bidirectionally transmit data via a SATA 3 bus. The PCH chipset AM20 is also connected with an SPI flash port AM24 to be able to bidirectionally transmit data at 64 Mb via an SPI (Serial Peripheral Interface) bus. The PCH chipset AM20 is further connected with a plurality of PCIe x1 slots AM25a to 25c to be able to bidirectionally transmit data via a plurality of PCIe x1 buses.

The AP-X motherboard AM includes an SIO (super I/O) chip (Nuvoton NCT6627UD) AM 30. The SIO chip AM30 is an input/output controller integrated circuit for a motherboard and combines interfaces for various low-bandwidth devices. The PCH chipset AM20 and the SIO chip AM30 are connected by an LPC (Low Pin Count) bus AM25, which is a bus for connecting low-bandwidth devices (legacy devices connected by the SIO chip) to a processor, to be able to bidirectionally transmit data at 33 MHz. The LPC bus AM25 is connected with a TPM (Trusted Platform Module) header AM26 to be able to transmit data unidirectionally. The TPM is a hardware tamper-resistant security chip to ensure security.

The SIO chip AM30 is connected with RS232C COM ports SK87 and SK91 (see FIG. 5) to be able to bidirectionally transmit data via ports A and B. The SIO chip AM30 is also connected with a PS2 KB/MS combo connector AM31 to be able to bidirectionally transmit data via a KB/MS bus. The SIO chip AM30 is further connected with a DGIO header AM 32 to be able to bidirectionally transmit data via a GPIO x8 bus. The SIO chip AM30 is still further connected with RS232, RXD, TXD, or GND COM ports AM 33a to 33d to be able to bidirectionally transmit data via internally provided ports C, D, E, and F. The SIO chip AM30 is still further connected with a fan AM34 provided for the CPU or the chassis to be able to bidirectionally transmit data via a fan bus. The fan AM34 is usually connected to a 3-pin connector.

In the present embodiment, the AP-X motherboard AM is referred to as controller 100 or game controller 100. The processor AM10 is referred to as main CPU 200. The DDR3 SRAM attached to a memory slot is referred to as main RAM 210. Furthermore, an SSD device SD2 is referred to as auxiliary storage device 220.

### <<Front Light 420 and Backlight M7>>

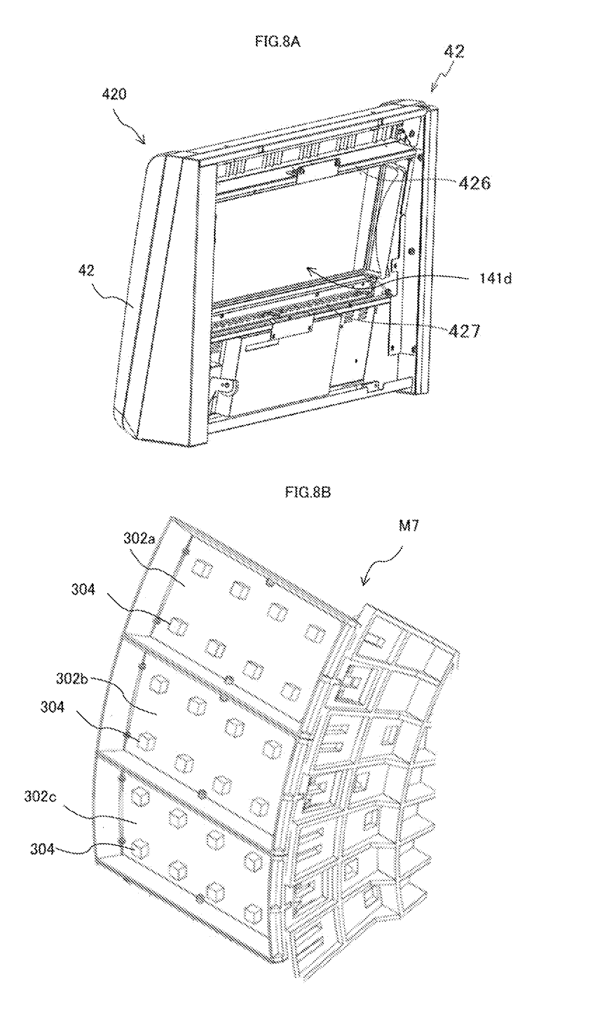

FIG. 8A is a perspective view of a front light 420 and FIG. 8B is a perspective view of a backlight M7.

The upper door unit 42 includes an upper illumination device 426 and a lower illumination device 427 as illustrated in FIG. 8A. FIG. 8A is a perspective view showing the inside of the upper door unit 42 from which the reel unit M1 is removed. The upper door unit 42 is provided with a symbol display area 141d.

The upper illumination device 426 is provided along the upper side of the symbol display area 141d and the lower illumination device 427 is provided along the lower side of the symbol display area 141d. The upper illumination device 426 primarily illuminates the upper area of the five mech reels M3a to M3e from the front. The lower illumination device 427 primarily illuminates the lower area of the five mech reels M3a to M3e from the front.

In the present embodiment, the upper illumination device 426 and the lower illumination device 427 have red, blue, yellow, and white LEDs (not shown). The upper illumination device 426 and the lower illumination device 427 are electrically connected with the lower light source board 4273 (see FIGS. 5 and 6). The upper illumination device 426 and the lower illumination device 427 are controlled by the main CPU 200 (processor AM10) to turn on, turn off, and select LEDs to light up.

The upper illumination device 426 and the lower illumination device 427 constitute the front light 420.

Behind each of the five mech reels M3a to M3e, a backlight unit M7 is provided. The backlight M7 has three modules 302a to 302c. The three modules 302a to 302c are disposed to fit the curved reel. The module 302a illuminates the top row in the symbol display area 141d; the module 302b illuminates the middle row in the symbol display area 141d; and the module 302c illuminates the bottom row in the symbol display area 141d. In this way, the top row, the middle row, and the bottom row in the symbol display area 141d can be illuminated separately.

On each of the modules 302a to 302c, eight LEDs 304 are disposed in a matrix. Each LED 304 is an aggregation of four kinds of LEDs: an LED for emitting red light, an LED for emitting blue light, an LED for emitting yellow light, and an LED for emitting white light.

The three modules 302a to 302c (backlight M7) are electrically connected with the lower light source board 4273 (see FIGS. 5 and 6). The three modules 302a to 302c are controlled by the main CPU 200 (processor AM10) to turn on, turn off, and select LEDs to light up. Accordingly, turning on, turning off, or selecting LEDs to light up can be controlled separately for the top row, the middle row, and the bottom row in the symbol display area 141d.

The lower light source board 4273 is connected with index sensors M101, magnetic encoders M102, and others (see FIGS. 5 and 6). The index sensors M101 are sensors to detect the origins of spin angles of the five mech reels M3a to M3e. The magnetic encoders M102 are sensors to detect spin angles of the five mech reels M3a to M3e.

The spin speed of a mech reel (one of the five mech reels M3a to M3e) can be calculated from detection signals from an index sensor M101 and a magnetic encoder M102. The calculated spin speed enables determination of the timing to sequentially turn on and turn off the three modules 302a to 302c. By sequentially turning on and turning off the three modules 302a to 302c with the timing matched with the spin speed, the symbols can be illuminated synchronously with the movement of a symbol. For example, when a 7 determined to be red is moving, the 7 can be illuminated in red synchronously with the movement by turning on the three modules 302a to 302c in red and then turning off one by one.

### <<State Transitions of Games>>

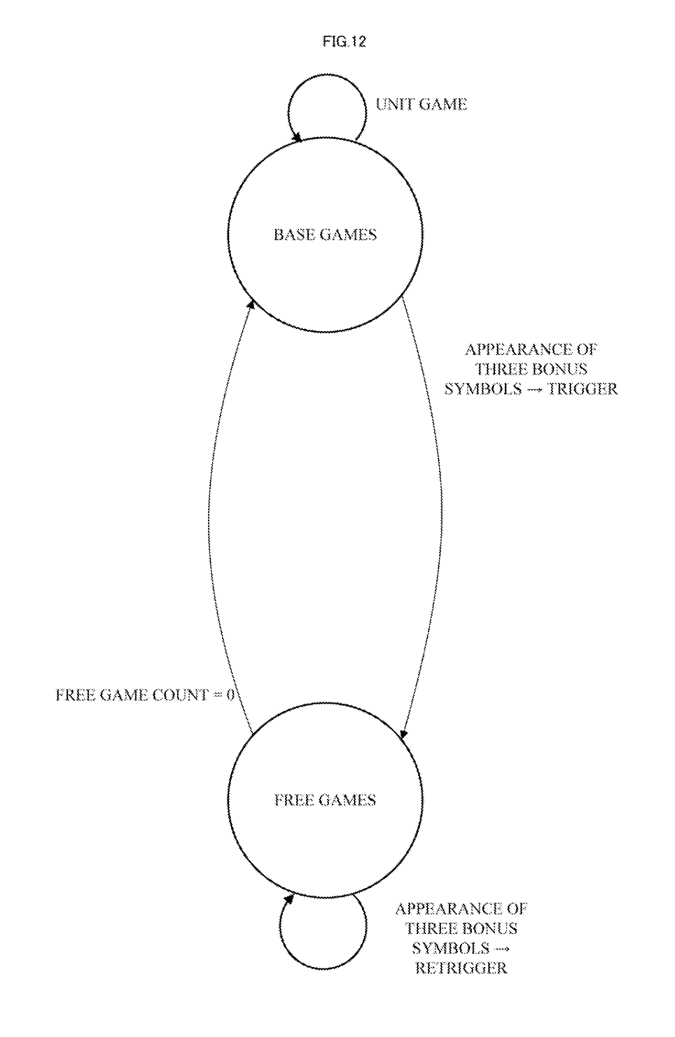

FIG. 12 is a diagram for illustrating state transitions in the slot machine 10. Specifically, FIG. 12 is a diagram for illustrating transitions between base game mode and free game mode.

The slot machine 10 has two game modes: base game mode and free game mode. The slot machine 10 offers unit games basically in the base game mode. When a free game trigger (event) occurs in the base game mode, the game mode changes to the free game mode.

As illustrated in FIG. 12, the base game mode repeats a unit game until a free game trigger is completed. The games in the base game mode are games to conduct unit games by spending (betting) gaming media such as medals. In the games in this base game mode, when one of the winning patterns illustrated in FIG. 14 is completed, an award in the amount in accordance with the payout for the winning pattern is paid out.

Completion of a winning pattern of BONUSes in the base game mode triggers a free game mode. Winning patterns of BONUSes can be also completed in the free game mode. In those cases, the free game mode is retriggered.

BONUSes are scatter symbols, which can make winning patterns independently from paylines. The number of BONUSes shown in the symbol display area 141d determines whether a winning pattern is completed or not.

Under the condition that a predetermined number, for example three, of BONUSes are determined to appear in the symbol display area 141d through symbol lottery processing, a winning pattern is completed. For example, when one BONUS on the mech reel M3a, one BONUS on the mech reel M3d, and one BONUS on the mech reel M3e are determined to appear in the symbol display area 141d, a winning pattern is completed.

Since the BONUSes are scatter symbols, a winning pattern is also completed when two BONUSes on the mech reel M3a and one BONUS on the mech reel M3d are determined to appear in the symbol display area 141d.

The game mode changes to a free game mode when the free game mode is triggered. The free game mode trigger results in two cases: a case where the game mode changes from the base game mode to the free game mode and a case where the free game mode is maintained (a case where the free game trigger acts as a retrigger to continue the free game mode).

The games in the free game mode are games to conduct unit games without spending gaming media such as medals. In the present embodiment, eight unit games are determined to be provided for a maximum number of games when entering the free game mode. The player can play unit games up to the maximum number in the free game mode.

As described above, winning patterns of BONUSes can be completed in the free game mode to retrigger the free game mode. When the free game mode is retriggered, eight unit games are added to increase the maximum number of unit games in the free game mode.

The free game mode ends when all the maximum number of unit games are consumed and the game mode returns to the base game mode.

### <Payline>

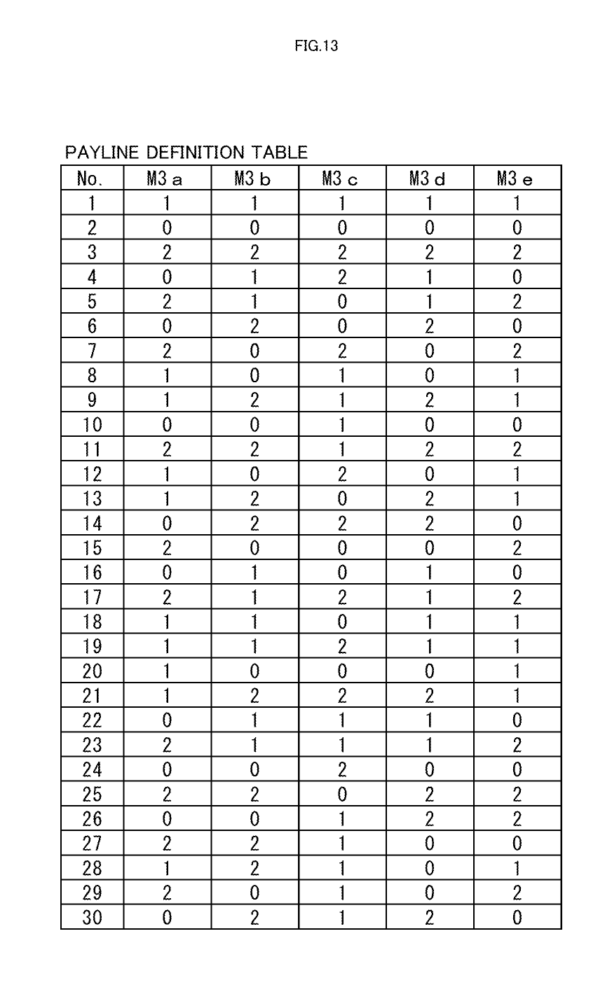

FIG. 13 is a view for illustrating an example of a payline definition table defining paylines employed in the slot machine 10. As mentioned above, in the slot machine 10 of the present embodiment, three rows of the top row, the middle row, and the bottom row in are defined in the symbol display area 141d as stop positions of symbols on the five mech reels M3a to M3e. In the slot machine 10, thirty paylines are defined within a five by three (five columns by three rows) symbol matrix. The payline definition table defines paylines each formed by connecting one of the top row, the middle row, and the bottom row of the five mech reels M3a to M3e in the symbol display area 141d.

For example, the payline definition table indicates that a payline (Payline No. 1) is formed of the middle row of the mech reel M3a (the first reel strip), the middle row of the mech reel M3b (the second reel strip), the middle row of the mech reel M3c (the third reel strip), the middle row of the mech reel M3d (the fourth reel strip), and the middle row of the mech reel M3e (the fifth reel strip).

In the slot machine 10 of the present embodiment, all of the thirty paylines are active regardless of the amount of bet or the player's choice. However, the paylines may be separately activated in accordance with the player's choice. The total number of paylines can be determined as appropriate depending on the size of the symbol matrix.

### <Payout Table>

FIG. 14 is a view for illustrating an example of a payout table. The payout table in FIG. 14 defines winning patterns of 11 kinds of symbols.

The payout table indicates relations among the kind of the symbols constituting the winning pattern, the Kind number, and the payout. The Kind number equals the number of constituent symbols of the winning pattern that are successively arranged from the left to the right along the payline. The slot machine 10 of the present embodiment determines a win or a loss on a left-to-right basis except for BONUSes. Accordingly, the payout is determined depending on the kind and the number of symbols successively arranged along a payline. Instead of the left-to-right basis, the number of symbols arranged along a payline, even if they are not successive, may determine whether a winning pattern is completed.

The first winning patterns are patterns where WILDs are successively arranged. In the present embodiment, successive WILDs are not assigned a direct payout. A WILD is a symbol to substitute for another symbol to make an advantageous winning pattern. When a winning pattern is completed with other symbols substituted by WILDs, a payout for the winning pattern is determined. In the present embodiment, however, a WILD cannot substitute for a BONUS.

The second winning patterns are patterns where three to five RED7s are successively arranged along a payline. For example, the payout when five RED7s are successively arranged along a payline is defined as 50000. When five RED7s are arranged along a payline, the 5Kind in RED7 is completed to win the RED7 progressive jackpot.

The third winning patterns are patterns where three to five BLUE7s are successively arranged along a payline. For example, the payout when five BLUE7s are successively arranged along a payline is defined as 10000. When five BLUE7s are arranged along a payline, the 5Kind in BLUE7 is completed to win the BLUE7 progressive jackpot.

The fourth winning patterns are patterns where three to five YELLOW7s are successively arranged along a payline. For example, the payout when five YELLOW7s are successively arranged along a payline is defined as 2000. When five YELLOW7s are arranged along a payline, the 5Kind in YELLOW7 is completed to win the YELLOW7 progressive jackpot.

The fifth winning patterns are patterns where three to five WHITE7s are successively arranged along a payline. For example, the payout when five WHITE7s are successively arranged along a payline is defined as 500. When five WHITE7s are arranged along a payline, the 5Kind in WHITE7 is completed to win the WHITE7 progressive jackpot.

As noted from the above, the payouts for the RED7s are defined as highest and the payouts for the WHITE7s are defined as lowest among the RED7s, BLUE7s, YELLOW7s, and WHITE7s.

The sixth winning patterns are patterns where three to five ANY7s are successively arranged along a payline. The winning patterns of ANY7 are patterns where symbols of at least two kinds out of RED7, BLUE7, YELLOW7, and WHITE7 are mixed and successively arranged along a payline. For example, the payout when two RED7s and one WHITE7 are arranged along a payline is defined as 5.

The seventh winning patterns are patterns where three to five 3BARs are successively arranged along a payline. For example, the payout when five 3BARs are successively arranged along a payline is defined as 150.

The eighth winning patterns are patterns where three to five 2BARs are successively arranged along a payline. For example, the payout when five 2BARs are successively arranged along a payline is defined as 100.

The ninth winning patterns are patterns where three to five 1BARs are successively arranged along a payline. For example, the payout when five 1BARs are successively arranged along a payline is defined as 75.

As noted from the above, the payouts for the 3BARs are highest and the payouts for the 1BARs are defined as lowest among the 3BARs, 2BARs, and 1BARs.

The tenth winning patterns are patterns where three to five ANYBARs are arranged along a payline. The winning patterns of ANYBAR are patterns where symbols of at least two kinds out of 3BAR, 2BAR, and 1BAR are mixed and successively arranged along a payline. For example, the payout when two 2BARs and one 1BAR are arranged along a payline is defined as 5.

The eleventh winning patterns are winning patterns where three to five BONUSes appear. As mentioned above, the BONUSes are scatter symbols. Accordingly, BONUSes arranged along a payline are not a requirement to complete a winning pattern and the number of appearing BONUSes determines whether an eleventh winning pattern is completed. The payout when three BONUSes appear is defined as 1; the payout when four BONUSes appear is defined as 2; and the payout when five BONUSes appear is defined as 5.

As mentioned above, when the condition is satisfied that three or more BONUSes are determined to appear in the symbol display area 141d through symbol lottery processing, a free game mode is triggered or retriggered. Accordingly, when three or more BONUSes are determined to appear in the symbol display area 141d through symbol lottery processing, both of the benefits of receiving payout and entering the free game mode are provided to the player.

### <Configuration of Reel Strips>

FIGS. 15 to 18 are symbol determination tables defining relations between reel strips (symbol arrays) of the five mech reels M3a to M3e and weights of individual symbols. The relations between the symbols and the weights indicated in FIGS. 15 to 18 are digitalized and stored in the SSD device SD2 of the auxiliary storage device 220.

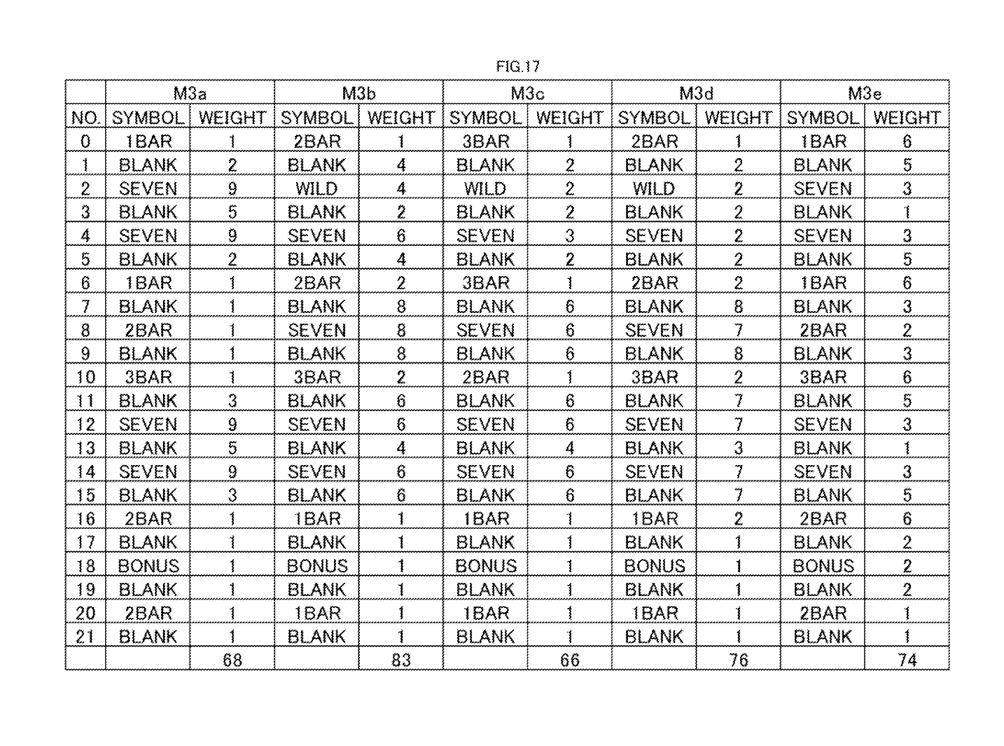

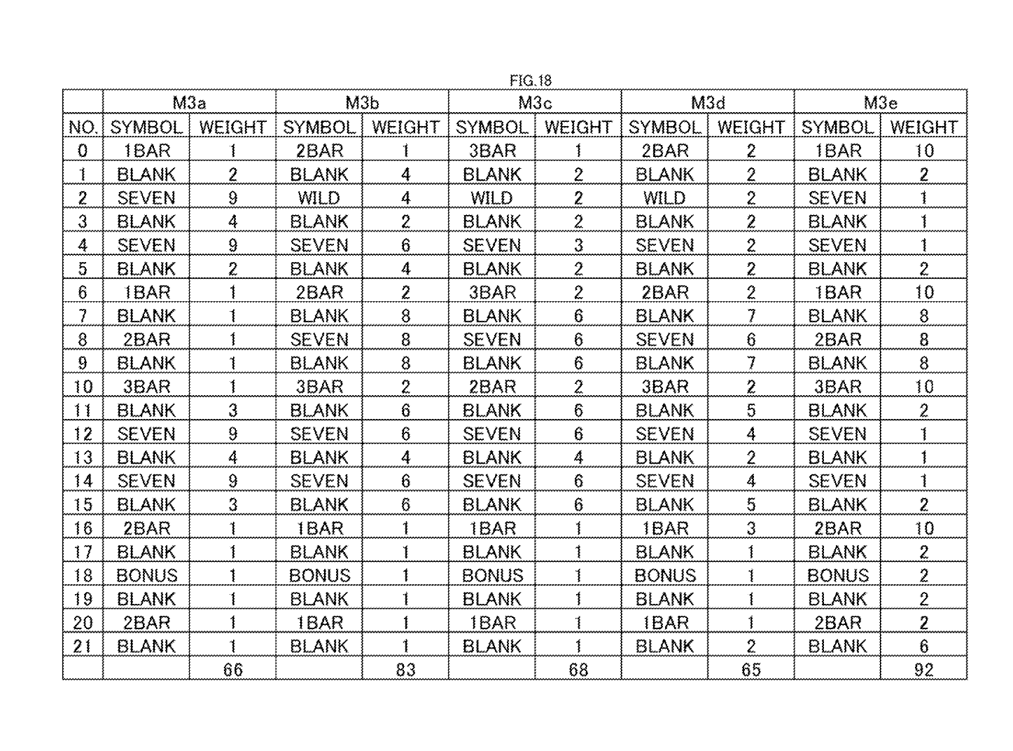

FIG. 15 is a symbol determination table for the five mech reels M3a to M3e in the base game mode and defines the weights in the base game mode. FIGS. 16 to 18 are symbol determination tables for the five mech reels M3a to M3e in the free game mode and define the weights in the free game mode. As will be described later, the symbol determination table of FIG. 16 defines the weights of a reel weight A; the symbol determination table of FIG. 17 defines the weights of a reel weight B; and the symbol determination table of FIG. 18 defines the weights of a reel weight C.

As shown in FIGS. 15 to 18, symbols are physically disposed on the five mech reels M3a to M3e; the five symbol arrays in the base game mode and the five symbol arrays in the free game mode are identical. The longitudinal directions in FIGS. 15 to 18 are the spin direction. Among the symbol determination tables in FIGS. 15 to 18, the weights are different so that the probabilities of one symbol to be determined for a to-be stopped symbol are different depending on the symbol determination table.

On each of the five mech reels M3a to M3e, total 22 symbols are disposed. Each of these 22 symbols is assigned a code number (0 to 21) to identify the symbol. Each of the five mech reels M3a to M3e is also assigned a reel number (1 to 5) to identify the reel. Identifying a reel number and a code number leads to identifying one symbol.

On the five mech reels M3a to M3e, WILDs, 7s, 3BARs, 2BARs, 1BARs, BONUSes, and BLANKs are disposed. The BLANKs are disposed alternately along the spin direction.

As to the WILDs, each of only the three mech reels M3b, M3c and M3d has one WILD.

As illustrated in FIGS. 15 to 18, the symbols of 7s are merely specified as 7 and are not specified about their colors. In the relations between symbols and weights, the 7s are merely specified that they are “7”. On the five mech reels M3a to M3e, the outlines of figure 7s are disposed.

As illustrated in the payout table in FIG. 14, however, the present embodiment is provided with four kinds of 7s, RED7, BLUE7, YELLOW7, and WHITE7, to determine a winning pattern or payout. As described above, a backlight M7 is provided behind each of the five mech reels M3a to M3e. The backlight M7 has four kinds of LEDs: an LED for emitting red light, an LED for emitting blue light, an LED for emitting yellow light, and an LED for emitting white light.

When a symbol 7 is illuminated with red light, it is regarded as RED7 to determine a winning pattern. In similar, when the symbol 7 is illuminated with blue light, it is regarded as BLUE7 to determine a winning pattern; when the symbol 7 is illuminated with yellow light, it is regarded as YELLOW7 to determine a winning pattern; and when the symbol 7 is illuminated with white light, it is regarded as WHITE7 to determine a winning pattern.

### <<Description of Program>>

Now, with reference to FIGS. 19 to 27, the program to be executed by the slot machine 10 is described.

### <Main Control Processing>

With reference to FIG. 19, main control processing is described. FIG. 19 is a flowchart of main control processing for the slot machine 10 according to the embodiment of the present invention. The game mode in this main control in FIG. 19 is the base game mode.

First, when the power is supplied to the slot machine 10, the main CPU 200 retrieves the authenticated game program and game system program from the auxiliary storage device 220 (SSD device SD2) through the AX-GMEM board G13, and writes the programs into the main RAM 210 (step S1911).

Next, the main CPU 200 conducts at-one-game-end initialization processing (step S1913). For example, the main CPU 200 clears data that becomes unnecessary after each game in the working areas of the main RAM 210, such as the bet count and the symbols determined by lottery.

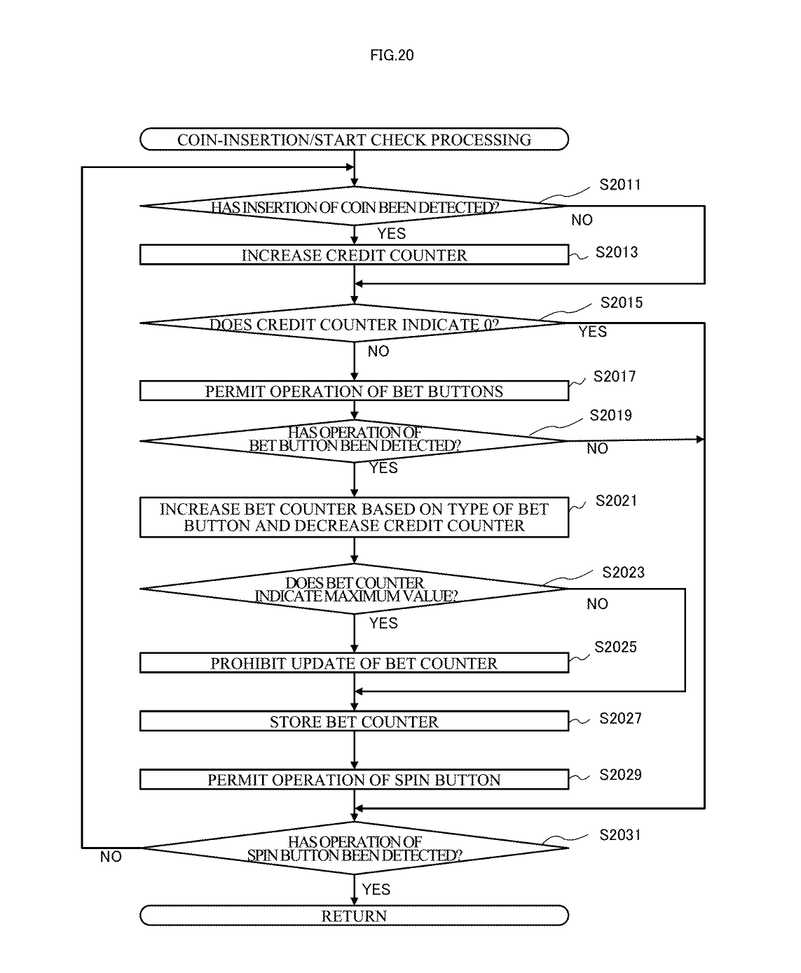

Next, the main CPU 200 performs coin-insertion/start check processing which is described later with reference to FIG. 20 (step S1915). In the processing, whether input from any of the BET buttons (operation buttons CP2 to CP6) or the spin button (operation button CP1) has been detected is checked.

Next, the main CPU 200 invokes and conducts color table determination processing which is described later with reference to FIG. 26 (S1917). In the processing, one color table is determined. As will be described later, the colors of the light emitted from the backlights M7 are controlled using the determined color table.

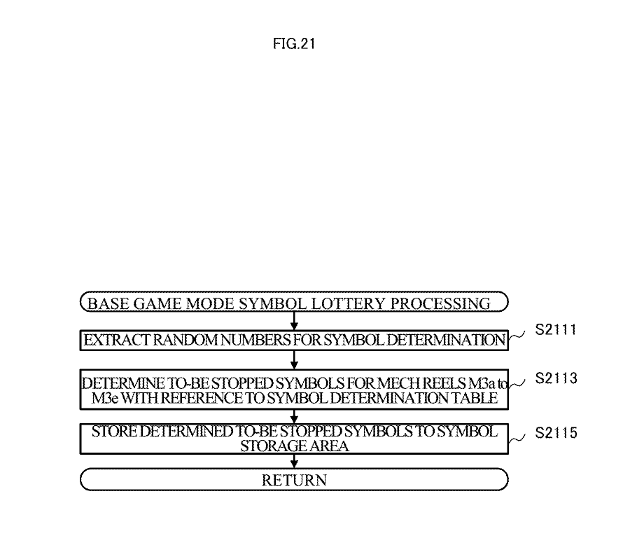

Next, the main CPU 200 conducts base game mode symbol lottery processing which is described later with reference to FIG. 21 (step S1919). In the processing, to-be stopped symbols are determined based on the random numbers for symbol determination in the base game mode. If BONUSes are determined to appear in the base game mode symbol lottery processing, a free game mode is triggered.

Next, the main CPU 200 conducts effect initiation processing (step S1921). Specifically, the main CPU 200 extracts a random number for determination of effects, and determines an effect content from the predefined plurality of effect contents by lottery, and executes the determined effect content with predetermined timing. For example, the main CPU 200 performs control to display a video for presentation effects on the upper liquid crystal display panel 131b, to output audio from a speaker (not shown), to flash a lamp (not shown), and to apply special effects to these.

The effect initiation processing of step S1921 can further determine predictive/li-zhi effects. The predictive/li-zhi effects are performed by controlling the spin speed, spin direction, spin time (spin angle), and time to stop of the individual stepping motors M51 for driving the five mech reels M3a to M3e. In the effect initiation processing, the main CPU 200 determines parameters for these spin speed, spin direction, spin time (spin angle), and time to stop of the stepping motors M51.

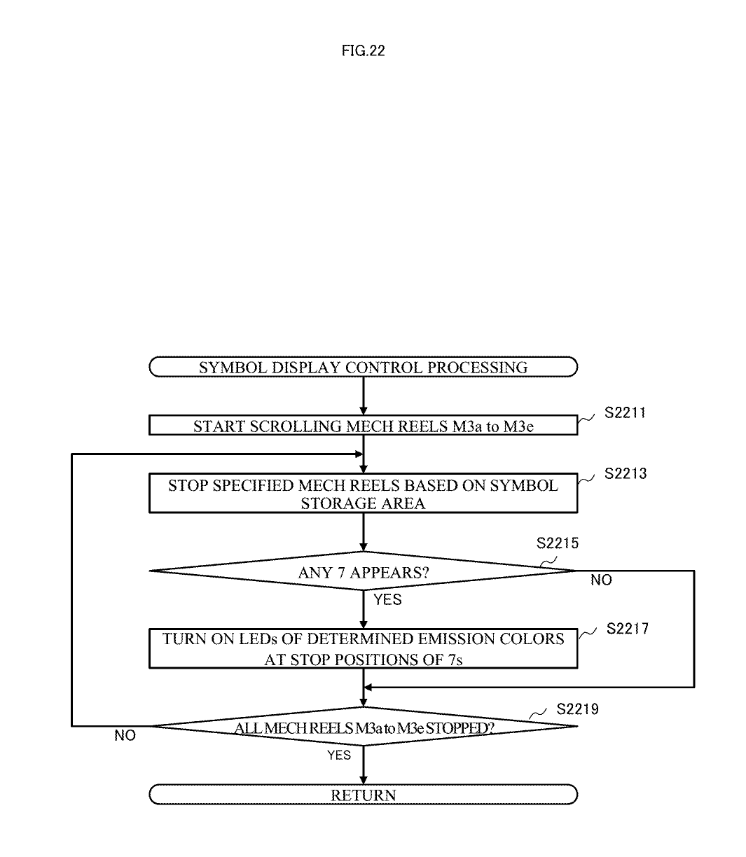

Next, the main CPU 200 conducts symbol display control processing which is described later with reference to FIG. 22 (step S1923). In the processing, spinning the five mech reels M3a to M3e (scrolling the five reel strips) is started, and the five to-be stopped symbols determined in the base game mode symbol lottery processing of step S1919 are stopped at predetermined positions.

Next, the main CPU 200 invokes the subroutine of payout determination processing illustrated in FIG. 23 to determine the amount of payout (step S1925). In the processing, a payout based on the payout table (see FIG. 14) is determined depending on the winning pattern, and is stored into a payout storage area (payout counter) provided in the main RAM 210.

Next, the main CPU 200 conducts payout processing (step S1927). The main CPU 200 adds the value stored in the payout storage area (payout counter) to the value stored in a credit storage area (credit counter) provided in the main RAM 210.

In addition, operations of a ticket printer (not shown) may be controlled to issue a ticket with a barcode on which a value stored in the payout counter is recorded. Alternatively, operations of the hopper (not shown) may be controlled to discharge coins corresponding to the value stored in the payout counter from the coin payout exit.

Next, the main CPU 200 stores an increment amount for each progressive jackpot (step S1929). The increment amount is stored each time a unit game is conducted in the base game mode; the gaming value in the amount corresponding to the accumulated increment amounts is provided to the player when winning the progressive jackpot.

In the present embodiment, the increment amount is added to the initial amount for the progressive jackpot in each unit game. For example, the initial amount for the progressive jackpot is fixed at 0.01 dollar in the present embodiment. Setting the initial amount for the progressive jackpot enables providing the initial amount when the progressive jackpot is won without being incremented, preventing the payout for the progressive jackpot from being internally calculated as 0.

The increment amount is determined depending on the bet count, and preset increment rate and denomination. The denomination is a unit value (minimum amount) to play a game. The denomination in the present embodiment is a range from $0.01 to $10.00; the manager of the game hall can set the denomination. When the denomination is set to be lower, the gaming value to be spent can be smaller; however, the payout to be provided at completion of a winning pattern is smaller as well. When the denomination is set to be higher, the gaming value to be spent can be larger; however, the payout to be provided at completion of a winning pattern can be larger.

The increment rate is a rate to be stored in one unit game; the manager of the game hall can set different increment rates for individual slot machines 10. The increment rate can be set by 0.01%. When the increment rate is set to be lower, the amount stored in the progressive jackpot cannot increase unless a larger number of unit games are conducted. When the increment rate is set to be higher, the amount stored in the progressive jackpot can increase even though a smaller number of unit games are conducted.

The following are examples in the case where the denomination is 1 cent (=$0.01) and the increment rate is 0.50%. It should be noted that the 30 paylines are fixed regardless of the bet count in the present embodiment; even if the bet per line is 1, the total bet count is 30.

In the first example where the bet per line is 1, the increment amount is calculated by 1 (bet)×30 (total bet count)×0.01 (denomination)×0.005 (increment rate), so that the increment amount is $0.0015. Accordingly, every time a unit game is conducted, $0.0015 of the increment amount is added to the initial amount for the progressive jackpot.

In the second example where the bet per line is 2, the increment amount is calculated by 2 (bet)×30 (total bet count)×0.01 (denomination)×0.005 (increment rate), so that the increment amount is $0.0030. Accordingly, every time a unit game is conducted, $0.0030 of the increment amount is added to the initial amount for the progressive jackpot.

In the third example where the bet per line is 3, the increment amount is calculated by 3 (bet)×30 (total bet count)×0.01 (denomination)×0.005 (increment rate), so that the increment amount is $0.0045. Accordingly, every time a unit game is conducted, $0.0045 of the increment amount is added to the initial amount for the progressive jackpot.

In the fourth example where the bet per line is 5, the increment amount is calculated by 5 (bet)×30 (total bet count)×0.01 (denomination)×0.005 (increment rate), so that the increment amount is $0.0075. Accordingly, every time a unit game is conducted, $0.0075 of the increment amount is added to the initial amount for the progressive jackpot.

In the fifth example where the bet per line is 10, the increment amount is calculated by 10 (bet)×30 (total bet count)×0.01 (denomination)×0.005 (increment rate), so that the increment amount is $0.015. Accordingly, every time a unit game is conducted, $0.015 of the increment amount is added to the initial amount for the progressive jackpot.

As described above, the player is provided with the gaming value in the amount corresponding to the accumulated increment amounts when winning a progressive jackpot.

The above-described increment rate may be set differently to each color of progressive jackpot. For example, the increment rate for the RED7 progressive jackpot can be set at 0.10%; the increment rate for the BLUE7 progressive jackpot can be set at 0.20%; the increment rate for the YELLOW7 progressive jackpot can be set at 0.40%; and the increment rate for the WHITE7 progressive jackpot can be set at 0.80%.

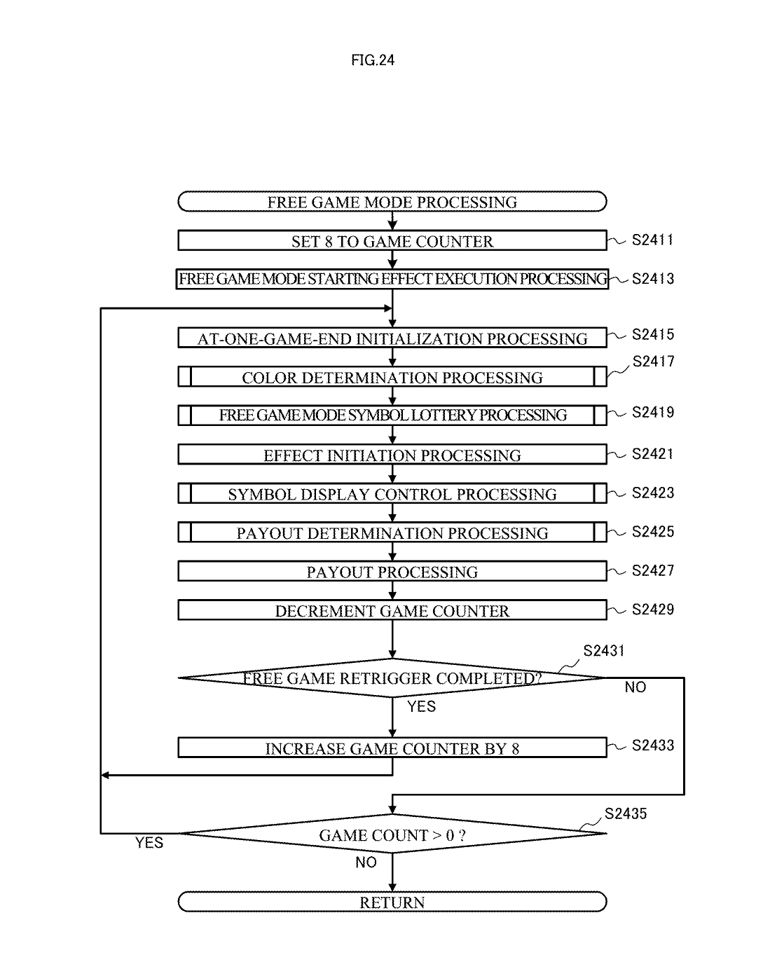

Next, the main CPU 200 determines whether or not a free game trigger is completed (step S1931). If the main CPU 200 determines that a free game trigger is completed, the main CPU 200 conducts free game mode processing which is described later with reference to FIG. 24 (step S1933) and returns the processing to step S1913.

If determining that a free game trigger is not completed in step S1931, the main CPU 200 returns the processing to step S1913.

### <Coin-Insertion/Start Check Processing>

Next, with reference to FIG. 20, coin-insertion/start check processing is described. FIG. 20 is a flowchart of the coin-insertion/start check processing for the slot machine 10 according to the embodiment of the present invention.

First, the main CPU 200 determines whether or not insertion of a coin has been detected by the coin counter (step S2011). When determining that the insertion of a coin has been detected, the main CPU 200 adds the value of the inserted coin to the value stored in the credit storage area (credit counter) (step S2013). It is to be noted that, in addition to the insertion of a coin, the main CPU 200 may determine whether or not insertion of a bill has been detected with a bill validator (e.g., the PTS terminal 700), and when determining that the insertion of a bill has been detected, the main CPU 200 may add a value corresponding to the amount of bill to the value stored in the credit counter.

After executing step S2013 or when determining in step S2011 that no insertion of a coin has been detected, the main CPU 200 determines whether or not the credit counter indicates zero (step S2015). When determining that the credit counter indicates a non-zero value, the main CPU 200 permits operation of the BET buttons (the operation buttons CP2 to CP6) (step S2017).

Next, the main CPU 200 determines whether or not operation of any of the BET buttons (the operation buttons CP2 to CP6) has been detected (step S2019). When detecting press of a BET button (one of the operation buttons CP2 to CP6) by the player with a BET switch, the main CPU 200 makes an addition to a value stored in a bet storage area (bet counter) provided in the main RAM 210 and makes a subtraction in the credit counter, based on the type of the BET button (one of the operation buttons CP2 to CP6) (step S2021).

The main CPU 200 then determines whether or not the bet counter indicates a maximum value (step S2023). When determining that the BET counter indicates the maximum value, the main CPU 200 prohibits updating the bet counter (step S2025).

After executing step S2025 or when determining in step S2023 that the bet counter does not indicate a maximum value, the main CPU 200 stores the value of the BET counter (step S2027). The free game mode allows conducting free games (unit games) without spending gaming media such as medals. Accordingly, free games can be started without bet; the bet counter cannot be determined through a BET button operation. For this reason, after entering the free game mode, the value of the bet counter in the base game mode before entering the free game mode is used. The value of the bet counter stored in step S2027 is retrieved and used after entering the free game mode.

Next, the main CPU 200 permits operation of the spin button (the operation button CP1) (step S2029).

After executing step S2029, when determining in step S2019 that no operation of BET buttons (the operation buttons CP2 to CP6) has been detected, or when determining in step S2015 that the credit counter 320 indicates zero, the main CPU 200 determines whether or not operation of the spin button (the operation button CP1) has been detected (step S2031). When determining that no operation of the spin button (the operation button CP1) has been detected, the main CPU returns to step S2011.

When determining that the operation of the spin button (the operation button CP1) has been detected, the main CPU 200 terminates the coin-insertion/start check processing.

### <Color Table Determination Processing>

FIG. 26 is a subroutine of color table determination processing. The color table determination processing is invoked and executed in the base game mode.

First, the main CPU 200 extracts a random number for determining a feature pattern ID (step S2611).

Next, the main CPU 200 determines a feature pattern ID with reference to the feature pattern table determination table (see FIG. 28) with the extracted random number (step S2613).

FIG. 28 is a table for illustrating an example of the feature pattern table determination table. The feature pattern IDs are 1 to 3. The feature pattern ID 1 is featured by selecting red, blue, yellow and white evenly (almost equally). The feature pattern ID 2 is featured by selecting the same color with high probability for the three mech reels M3a to M3c. The feature pattern ID 3 is featured by selecting the same color with high probability for the five mech reels M3a to M3e.

Determining a feature pattern with a feature pattern table determination table enables red, blue, yellow, and white to be selected equally, or at least one of red, blue, yellow, and white to be selected with high probability.

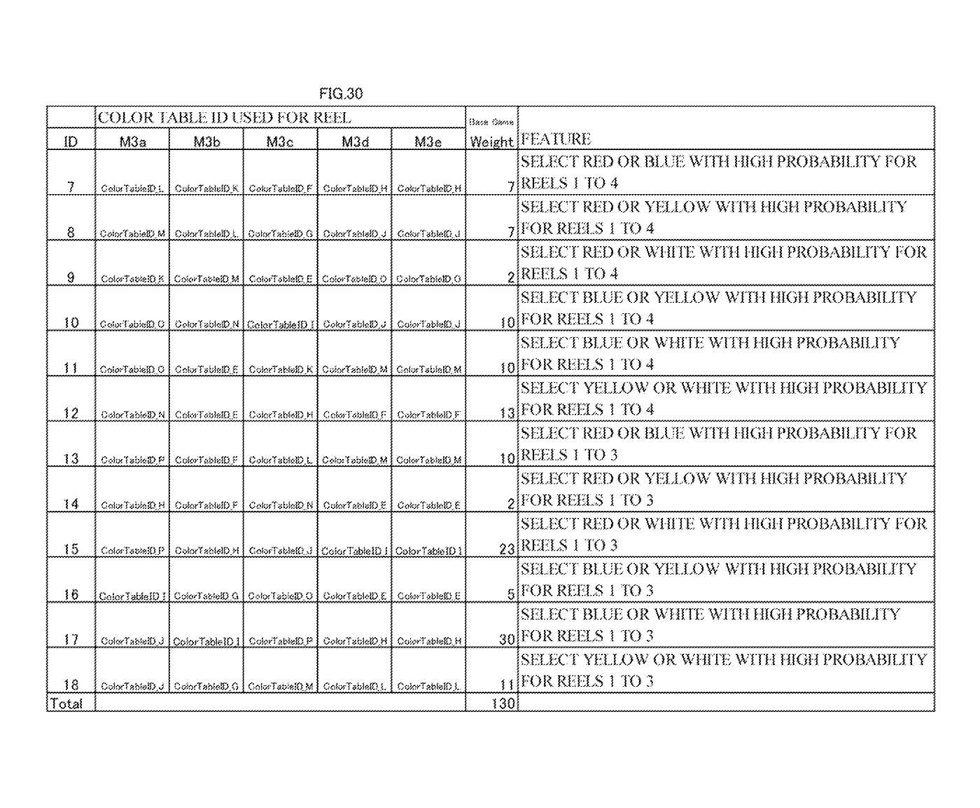

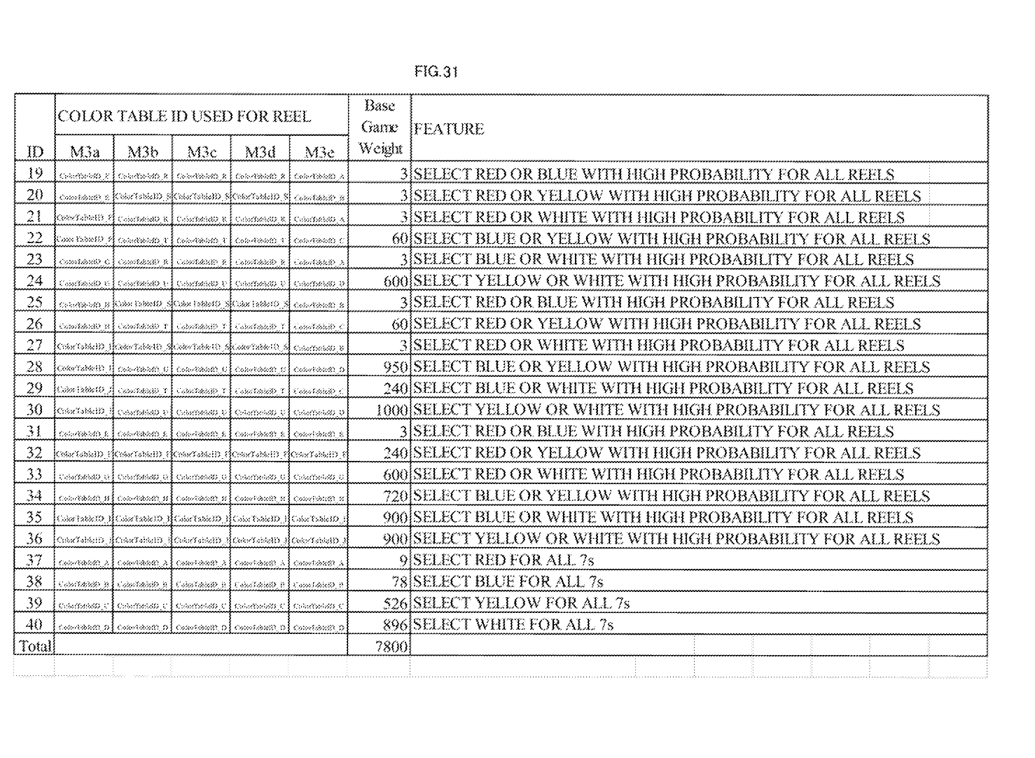

The weight of the feature pattern ID 1 is 94; the weight of the feature pattern ID 2 is 87; and the weight of the feature pattern ID 3 is 19. As will be described later, in the case of the feature pattern ID 1, the reel pattern determination table of FIG. 29 is selected; in the case of the feature pattern ID 2, the reel pattern determination table of FIG. 30 is selected; and in the case of the feature pattern ID 3, the reel pattern determination table of FIG. 31 is selected.

Next, the main CPU 200 extracts a random number for determining a reel pattern ID with the feature pattern ID determined in the processing of step S2613 (step S2615). Specifically, when the feature pattern ID is 1, the main CPU 200 extracts a random number in accordance with the weights in the reel pattern determination table of FIG. 29; when the feature pattern ID is 2, the main CPU 200 extracts a random number in accordance with the weights in the reel pattern determination table of FIG. 30; and when the feature pattern ID is 3, the main CPU 200 extracts a random number in accordance with the weights in the reel pattern determination table of FIG. 31.

Next, the main CPU 200 determines a color table ID for each of the mech reels M3a to M3e with reference to the reel pattern table determination table (step S2617). Specifically, when the feature pattern ID is 1, the main CPU 200 refers to the reel pattern determination table of FIG. 29 to determine color table IDs; when the feature pattern ID is 2, the main CPU 200 refers to the reel pattern determination table of FIG. 30 to determine color table IDs; and when the feature pattern ID is 3, the main CPU 200 refers to the reel pattern determination table of FIG. 31 to determine color table IDs.

Each of the reel pattern determination tables of FIGS. 29 to 31 specifies a color table ID (A to U) for each of the five mech reels M3a to M3e. FIG. 32 is a table providing a color table collection. The color table collection in FIG. 32 consists of 21 color tables A to U. One of the 21 color tables A to U can be designated with a color table ID.

The color table collection of FIG. 32 specifies the weights of red, blue, yellow, and white for the 21 color tables A to U. As described above, one color table can be designated with a color table ID. With reference to one of the reel pattern determination tables of FIGS. 29 to 31, different color tables can be individually determined for the five mech reels M3a to M3d. As will be described later, colors can be determined separately for the five mech reels M3a to M3e using the determined color tables.

In the processing of steps S2611 to S2617, the main CPU 200 first determines one feature pattern from the feature pattern table determination table of FIG. 28, which determines one reel pattern determination table from the reel pattern determination tables of FIGS. 29 to 31. The main CPU 200 then determines a combination of color tables for the five mech reels M3a to M3e from the determined one reel pattern determination table. The combination of color tables is associated with the five mech reels M3a to M3e one by one. The present embodiment thus determines colors for the five mech reels M3a to M3e using different color tables individually associated with the five mech reels M3a to M3e.

Using different color tables individually associated with the five mech reels M3a to M3e enables separately determining equal likelihood or weighted likelihood in selecting a color for the individual reels. As a result, winning patterns to be completed can be increased and completion of winning patterns can be controlled. For example, winning patterns to be completed with high probability and winning patterns to be completed with low probability can be provided; and the feature pattern table determination table, the reel pattern table determination table, and the color tables can be defined to balance the benefit for the player and the benefit for the game hall.

Next, the main CPU 200 selects the mech reel M3a (step S2619).

Next, the main CPU 200 extracts a random number for determining a color (step S2621). The random number for determining a color is a value to determine a color from a color table in FIG. 32; it is an integer within the range from 1 to 20.

Next, the main CPU 200 determines a color for a 7 on the mech reel M3a with reference to the color table for the mech reel M3a with the random number extracted in the processing of step S2621 (step S2623).

Next, the main CPU 200 determines whether colors have been determined for all the 7s disposed on the mech reel M3a (step S2625). When determining that colors have not been determined for all the 7s disposed on the mech reel M3a, the main CPU 200 returns to step S2621.

Repeating the processing of steps S2621 and S2623 leads to determining colors for all the 7s disposed on the mech reel M3a. As shown in FIG. 15, the 7s disposed on the mech reel M3a are four 7s of Nos. 2, 4, 12, and 14. The colors for these four 7s can be determined by repeating the processing of steps S2621 and S2623.

When determining that colors have been determined for all the 7s disposed on the mech reel M3a, the main CPU 200 stores the colors for all the 7s disposed on the mech reel M3a (step S2627).

Next, the main CPU 200 determines whether colors for all the five mech reels M3a to M3e have been determined (step S2629). When determining that colors have not been determined for all the five mech reels M3a to M3e, the main CPU 200 returns to step S2621.

Repeating the processing of steps S2621 to S2629 leads to determining colors for all the 7s disposed on the five mech reels M3a to M3e. Specifically, the four 7s of Nos. 2, 4, 12, and 14 disposed on each of the mech reels M3a and M3e and the four 7s of Nos. 4, 8, 12, and 14 on each of the mech reels M3b, M3c, and M3d, are determined.

When determining that colors for the five mech reels M3a to M3e have been determined, the main CPU 200 exits this subroutine.

### <Base Game Mode Symbol Lottery Processing>

Next, with reference to FIG. 21, base game mode symbol lottery processing is described. FIG. 21 is a flowchart of the symbol lottery processing for the slot machine 10 according to the embodiment of the present invention.

First, the main CPU 200 extracts five random numbers for symbol determination (step S2111).

The main CPU 200 then determines to-be stopped symbols for the five mech reels M3a to M3e by lottery with the five random numbers (step S2113). That is to say, the main CPU 200 determines a to-be stopped symbol for the mech reel M3a with the first random number, determines a to-be stopped symbol for the mech reel M3b with the second random number, determines a to-be stopped symbol for the mech reel M3c with the third random number, determines a to-be stopped symbol for the mech reel M3d with the fourth random number, and determines a to-be stopped symbol for the mech reel M3e with the fifth random number.

In the processing of step S2113, the main CPU 200 determines five to-be stopped symbols with reference to the symbol determination table. In the present embodiment, the symbol determination table for the base game mode is the table illustrated in FIG. 15. Accordingly, when the game mode is the base game mode, the main CPU 200 determines five to-be stopped symbols with reference to the symbol determination table for base game mode illustrated in FIG. 15.

The main CPU 200 extracts five random numbers for symbol determination, and determines one symbol to be a to-be stopped symbol for each of the five mech reels M3a to M3e with reference to the symbol determination table in FIG. 15.

Through the processing of step S2113, five to-be stopped symbols for the five mech reels M3a to M3e are determined. Each of the five mech reels M3a to M3e is controlled to be stopped so that the determined to-be stopped symbol stops at the middle row of the symbol matrix (the middle row of the symbol display area 141d) through the processing of step S2213 in FIG. 22.

Next, the main CPU 200 stores the determined to-be stopped symbols for the individual mech reels to a symbol storage area provided in the main RAM 210 (step S2115).

As described above, in this symbol lottery processing, five to-be stopped symbols are determined with the probabilities in accordance with the weights indicated in FIG. 15. However, all the weights can be specified as the same (equal probabilities) to define the drawing probabilities for the five to-be stopped symbols in accordance with the numbers of the symbols on the five mech reels M3a to M3e.

### <Symbol Display Control Processing>

Next, with reference to FIG. 22, symbol display control processing is described. FIG. 22 is a flowchart of the symbol display control processing for the gaming machine according to the embodiment of the present invention.

The main CPU 200 starts scrolling the five mech reels M3a to M3e displayed in the symbol display area 141d of the lower display unit 141 (step S2211).

The scrolling speeds and directions of the five mech reels M3a to M3e are controlled with the parameters for predictive/li-zhi effects determined in the effect initiation processing of step S1921 or step S2421.

Next, the main CPU 200 stops one or more mech reels specified out of the five mech reels M3a to M3e based on the symbol storage area (step S2213). The mech reels to be stopped or the time to stop are determined with the parameters for predictive/li-zhi effects determined in the effect initiation processing of step S1921 or step S2421.

Next, the main CPU 200 determines whether any 7 has appeared in the symbol display area 141d (step S2215).

When determining that one or more 7s have appeared in the symbol display area 141d, the main CPU 200 turns on the LEDs at the stop positions of the 7s in the symbol display area 141d in the color determined in the color table determination processing in FIG. 26 or the color determination processing in FIG. 27 (step S2217).

This step illuminates the 7s shown in the symbol display area 141d in the color determined in the color table determination processing in FIG. 26 or the color determination processing in FIG. 27 in order of stopping the mech reels. Accordingly, the player can successively recognize that each 7 that has appeared in the symbol display area 141d is a RED7, a BLUE7, a YELLOW7, or a WHITE7 every time one or more mech reels are stopped.

As described above, when a plurality of 7s are to appear in the symbol display area 141d, the main CPU 200 can separately determine colors for all the 7s to be shown in the symbol display area 141d. In the foregoing step S2217, all the 7s shown in the symbol display area 141d can be illuminated by turning on the LEDs at the positions of the 7s in the determined emission colors.

Meanwhile in the foregoing processing of S2211, the main CPU 200 successively turns on and off the three modules 302a to 302c of the backlight M7 to illuminate the symbols synchronously with the movement of the symbols. For example, when a 7 determined to be red is moving, three modules 302a to 302c are sequentially turned on to light up in red and then turned off to synchronously illuminate the moving 7.

Next, the main CPU 200 determines whether all the five mech reels M3a to M3e are stopped (step S2219). When determining that all the five mech reels M3a to M3e are not stopped, the main CPU 200 returns the processing to step S2213. When determining that all the five mech reels M3a to M3e are stopped, the main CPU 200 exits this subroutine.

In the present embodiment, after the start of scrolling the five mech reels M3a to M3e until the stop of the scrolling, various predictive/li-zhi effects are performed with the five mech reels M3a to M3e. The main CPU 200 controls the spin speeds, spin directions, and spin times (spin angles) of the stepping motors M51 for driving the five mech reels M3a to M3e to perform the predictive/li-zhi effects.

The foregoing has provided an example that sequentially illuminates the 7s that have appeared in the symbol display area 141d with the emission colors determined in the color table determination processing in FIG. 26 or the color determination processing in FIG. 27 each time one or more mech reels out of the five mech reels M3a to M3e are stopped. However, another example can be provided that does not illuminate the 7s until all the five mech reels M3a to M3e are stopped, and simultaneously illuminates all the 7s shown in the symbol display area 141d after all the five mech reels M3a to M3e are stopped. The player cannot see the illumination color for each 7 already shown in the symbol display area 141d, in other words, the player cannot know each 7 is a RED7, a BLUE7, a YELLOW7, or a WHITE7, until all the five mech reels M3a to M3e are stopped; such processing enables the player to feel expectation or anxiety for a winning pattern until the mech reels are stopped.

### <Payout Determination Processing>

Next, with reference to FIG. 23, payout determination processing is described. FIG. 23 is a flowchart of the payout determination processing for the slot machine 10 according to the embodiment of the present invention.

First, the main CPU 200 determines the kinds of the stopped symbols in accordance with the emission color (step S2311). When a 7 is illuminated in red, the main CPU 200 determines that the 7 is a RED7. When a 7 is illuminated in blue, the main CPU 200 determines that the 7 is a BLUE7. When a 7 is illuminated in yellow, the main CPU 200 determines that the 7 is a YELLOW7. When a 7 is illuminated in white, the main CPU 200 determines that the 7 is a WHITE7.

Next, the main CPU 200 determines whether any winning pattern is completed based on the symbols stored in the symbol storage area and the colors determined in step S2311 with reference to the payout table in FIG. 14 (step S2313).

Next, the main CPU 200 determines whether any progressive jackpot is won (step S2315). In the present embodiment, when five RED7s are arranged along a payline to complete a 5Kind in RED7, the RED7 progressive jackpot is won; when five BLUE7s are arranged along a payline to complete a 5Kind in BLUE7, the BLUE7 progressive jackpot is won; when five YELLOW7s are arranged along a payline to complete a 5Kind in YELLOW7, the YELLOW7 progressive jackpot is won; and when five WHITE7s are arranged along a payline to complete a 5Kind in WHITE7, the WHITE7 progressive jackpot is won.

Next, the main CPU 200 determines the amount of payout for the progressive jackpot that is won (step S2317). This amount of payout is so-called jackpot award. In the present embodiment, the payouts are 50000 (credits) at winning the RED7 progressive jackpot, 10000 (credits) at winning the BLUE7 progressive jackpot, 2000 (credits) at winning the YELLOW7 progressive jackpot, and 500 (credits) at winning the WHITE7 progressive jackpot in the case where the bet per line is 1 (see FIG. 14).

The following description is based on an assumption that the denomination be 1 cent (=$0.01).

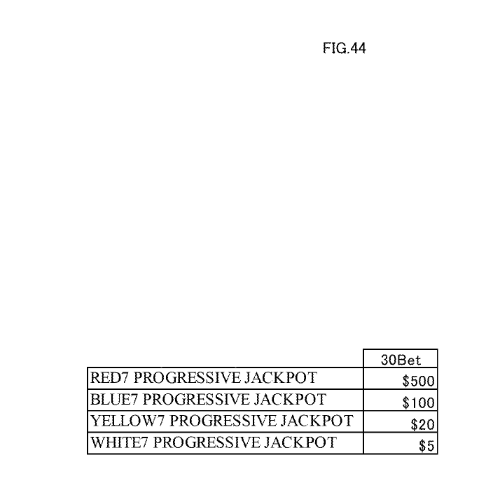

When winning the RED7 progressive jackpot, the amounts of payout are as follows. In the case where the bet per line is 1, the amount of payout=1 (bet)×0.01 (denomination)×50000 (credits)=500 (dollars) (see FIG. 44). In the case where the bet per line is 2, the amount of payout=2 (bets)×0.01 (denomination)×50000 (credits)=1000 (dollars). In the case where the bet per line is 3, the amount of payout=3 (bets)×0.01 (denomination)×50000 (credits)=1500 (dollars). In the case where the bet per line is 5, the amount of payout=5 (bets)×0.01 (denomination)×50000 (credits)=2500 (dollars). In the case where the bet per line is 10, the amount of payout=10 (bets)×0.01 (denomination)×50000 (credits)=5000 (dollars).

When winning the BLUE7 progressive jackpot, the amounts of payout are as follows. In the case where the bet per line is 1, the amount of payout=1 (bet)×0.01 (denomination)×10000 (credits)=100 (dollars) (see FIG. 44). In the case where the bet per line is 2, the amount of payout=2 (bets)×0.01 (denomination)×10000 (credits)=200 (dollars). In the case where the bet per line is 3, the amount of payout=3 (bets)×0.01 (denomination)×10000 (credits)=300 (dollars). In the case where the bet per line is 5, the amount of payout=5 (bets)×0.01 (denomination)×10000 (credits)=500 (dollars). In the case where the bet per line is 10, the amount of payout=10 (bets)×0.01 (denomination)×10000 (credits)=1000 (dollars).

When winning the YELLOW7 progressive jackpot, the amounts of payout are as follows. In the case where the bet per line is 1, the amount of payout=1 (bet)×0.01 (denomination)×2000 (credits)=20 (dollars) (see FIG. 44). In the case where the bet per line is 2, the amount of payout=2 (bets)×0.01 (denomination)×2000 (credits)=40 (dollars). In the case where the bet per line is 3, the amount of payout=3 (bets)×0.01 (denomination)×2000 (credits)=60 (dollars). In the case where the bet per line is 5, the amount of payout=5 (bets)×0.01 (denomination)×2000 (credits)=100 (dollars). In the case where the bet per line is 10, the amount of payout=10 (bets)×0.01 (denomination)×2000 (credits)=200 (dollars).

When winning the WHITE7 progressive jackpot, the amounts of payout are as follows. In the case where the bet per line is 1, the amount of payout=1 (bet)×0.01 (denomination)×500 (credits)=5 (dollars) (see FIG. 44). In the case where the bet per line is 2, the amount of payout=2 (bets)×0.01 (denomination)×500 (credits)=10 (dollars). In the case where the bet per line is 3, the amount of payout=3 (bets)×0.01 (denomination)×500 (credits)=15 (dollars). In the case where the bet per line is 5, the amount of payout=5 (bets)×0.01 (denomination)×500 (credits)=25 (dollars). In the case where the bet per line is 10, the amount of payout=10 (bets)×0.01 (denomination)×500 (credits)=50 (dollars).

Next, the main CPU 200 calculates the summed amount by adding the amounts stored in the processing of step S1929 in FIG. 19 to the amount of payout determined in the processing of step S2317.

For example, when winning the YELLOW7 progressive jackpot under the conditions that the denomination is 1 cent (=$0.01), that the initial amount for the progressive jackpot is $0.01, and that the accumulated increment amounts is $10.57, the summed amount in the case where the bet per line is 1 is $20.00 (amount of payout)+$10.57+$0.01=$30.58. In the case where the bet per line is 2, the summed amount=$40.00 (amount of payout)+$10.57+$0.01=$50.58. In the case where the bet per line is 3, the summed amount=$60.00 (amount of payout)+$10.57+$0.01=$70.58. In the case where the bet per line is 5, the summed amount=$100.00 (amount of payout)+$10.57+$0.01=$110.58. In the case where the bet per line is 10, the summed amount=$200.00 (amount of payout)+$10.57+$0.01=$210.58.

Next, the main CPU 200 stores the summed amount calculated in step S2319 to the payout storage counter (step S2321).

Next, the main CPU 200 resets the accumulated increment amounts by inputting the initial amount for the progressive jackpot to the amount of accumulated increment amounts (step S2323) and exits this subroutine. As noted from this description, if a progressive jackpot is won and an award is provided, the main CPU 200 resets the amount of accumulated increment amounts to the initial amount for the progressive jackpot.

When determining that no progressive jackpot is won in the processing of step S2315, the main CPU 200 determines whether any winning pattern is completed with any of the kinds of the symbols determined in step S2311 (step S2325). It should be noted that this determination exclude completion of progressive jackpots.

Next, if a winning pattern is completed, the main CPU 200 determines the amount of payout based on the payout associated with the completed winning pattern with reference to the symbol storage area and the payout table (FIG. 14) (step S2327).

Next, the main CPU 200 stores the determined amount of payout in the payout counter in the payout storage area (step S2329) and exits this subroutine.

If determining that no winning pattern is completed in the determination of step S2325, the main CPU 200 immediately exits this subroutine.

### <Free Game Mode Processing>

With reference to FIG. 24, free game mode processing is described. FIG. 24 is a flowchart of the free game mode processing for the slot machine 10 according to the embodiment of the present invention.

First, the main CPU 200 sets 8 to the game counter for the unit games in the free game mode (step S2411). In the free game mode, unit games can be conducted eight times at maximum except for the case where the free game mode is retriggered.

Next, the main CPU 200 conducts free game mode starting effect execution processing (S2413). The main CPU 200 extracts a random number for determination of effects, and determines one of the effect contents for starting the free game mode from the predefined plurality of effect contents by lottery, and executes the determined free game mode starting effects. For example, the main CPU 200 performs control to display a video for presentation effects on the upper liquid crystal display panel 131b, to output audio from a speaker (not shown), to flash a lamp (not shown), and to apply special effects to these. These effects notify the player of entering the free game mode.

Next, the main CPU 200 conducts at-one-game-end initialization processing (step S2415). For example, the main CPU 200 clears data that becomes unnecessary after each game in the working areas of the main RAM 210, such as the symbols determined by lottery.

Next, the main CPU 200 invokes and conducts color determination processing to be described later with reference to FIG. 27 (step S2417). Through this processing, one color to illuminate the 7s is determined. As will be described later, the determined color is emitted from the backlights M7.

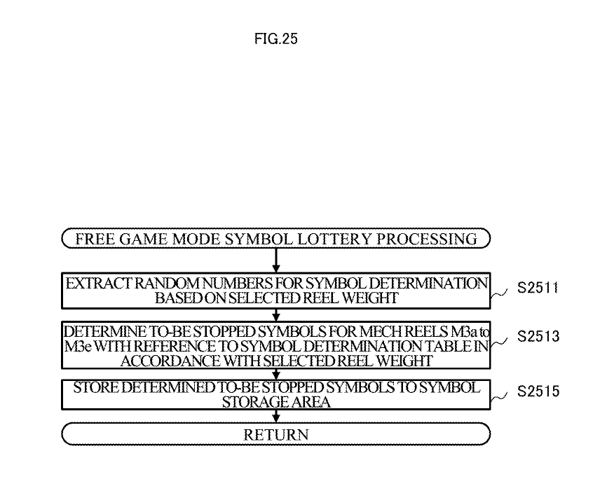

Next, the main CPU 200 conducts free game mode symbol lottery processing described with reference to FIG. 25 (step S2419). In the processing, to-be stopped symbols are determined based on random numbers for symbol determination in the free game mode. If a predetermined number of BONUSes are determined to appear in the free game mode symbol lottery processing, the free game mode is retriggered.

Next, the main CPU 200 conducts effect initiation processing (step S2421). Specifically, the main CPU 200 extracts a random number for determination of effects, and determines one of the effect contents from the predefined plurality of effect contents by lottery, and executes the determined effect contents with predetermined timing. For example, the main CPU 200 performs control to display a video for presentation effects on the upper liquid crystal display panel 131b, to output audio from a speaker (not shown), to flash a lamp (not shown), and to apply special effects to these.

The effect initiation processing of step S2421 can determine predictive/li-zhi effects. The predictive/li-zhi effects are performed by controlling the spin speed, spin direction, spin time (spin angle), and time to stop of the individual stepping motors M51 for driving the five mech reels M3a to M3e. In the effect initiation processing, the main CPU 200 determines parameters for these spin speed, spin direction, spin time (spin angle), and time to stop of the stepping motors M51.

Next, the main CPU 200 conducts symbol display control processing described with reference to FIG. 22 (step S2423). In this processing, spinning the five mech reels M3a to M3e (scrolling the five reel strips) is started and the five to-be stopped symbols determined in the free game mode symbol lottery processing of step S2419 are stopped at the predetermined positions.

Next, the main CPU 200 invokes a subroutine of the payout determination processing illustrated in FIG. 23 to determine the amount of payout (step S2425). In this processing, the main CPU 200 determines a payout based on the payout table (see FIG. 14) in accordance with the winning pattern and stores the result in the payout storage area (payout counter) provided in the main RAM 210.

Next, the main CPU 200 conducts payout processing (step S2427). The main CPU 200 adds the value stored in the payout storage area (payout counter) to a value stored in a credit storage area (credit counter) provided in the main RAM 210.

It is to be noted that operations of a ticket printer (not shown) may be controlled to issue a ticket with a barcode on which a value stored in the payout counter is recorded. Alternatively, operations of a hopper (not shown) may be controlled to discharge coins corresponding to the value stored in the payout counter from a coin payout exit.

Next, the main CPU 200 decrements the game count by one (step S2429).

Next, the main CPU 200 determines whether a retrigger for the free game mode is completed (step S2431). When determining that a retrigger for the free game mode is completed, the main CPU 200 adds 8 to the game count (step S2433) and returns the processing to step S2415. As noted, when a retrigger for the free game mode is completed, the number of games is increased by 8.

When determining that a retrigger is not completed, the main CPU 200 determines whether the game count is more than zero (step S2435).

When determining that the game count is more than zero, the main CPU 200 returns the processing to step S2415. When determining that the game count is zero, the main CPU 200 exits this subroutine.

In the present embodiment, storing an increment amount (see step S1929 in FIG. 19) is not performed in the free game mode. The storing an increment amount is performed only in the base game mode.

### <Color Determination Processing>

FIG. 27 is a subroutine of color determination processing. The color determination processing is invoked and executed in a free game mode.

In a free game mode, a color for the 7s is selected in each unit game; all the 7s have the same color. That is to say, a color for the 7s is selected in each unit game in the free game mode so that the 7s disposed on the five mech reels M3a to M3e have the same color. Accordingly, unlike in the base game mode, the weights for selecting a color do not need to be determined for each of the five mech reels M3a to M3e in the free game mode. As will be described later, the color for the 7s is determined using a free game color determination table shown in FIG. 33 in each unit game.

First, the main CPU 200 extracts a random number for color determination (step S2711). The random number is a value to determine a color from the free game color determination table in FIG. 33 and is an integer within the range from 1 to 100. The free game color determination table in FIG. 33 defines weights of red, blue, yellow, and white. The weight increases in the order of red, blue, yellow, and white to increase the probability of selection.

Next, the main CPU 200 determines a color with reference to the free game color determination table in FIG. 33 (step S2713).

Next, the main CPU 200 stores the color determined in the processing of step S2713 (step S2715).

Next, the main CPU 200 determines whether the determined color is either red or blue (step S2717). When determining the determined color as red or blue, the main CPU 200 selects a symbol determination table in accordance with the reel weight C in FIG. 18 (step S2719) and exits this subroutine.

When determining that the determined color is neither red nor blue, the main CPU 200 determines whether the determined color is yellow (step S2721). When determining that the determined color is yellow, the main CPU 200 selects a symbol determination table in accordance with the reel weight B in FIG. 17 (step S2723) and exits this subroutine.

When determining that the determined color is not yellow, the main CPU 200 determines whether the determined color is white (step S2725). When determining that the determined color is white, the main CPU 200 selects a symbol determination table in accordance with the reel weight A in FIG. 16 (step S2727) and exits this subroutine.

When determining that the determined color is not white, the main CPU 200 immediately exits this subroutine.

The main CPU 200 executes the symbol lottery processing in step S2419 of FIG. 24 (see FIG. 25) using the symbol determination table (FIG. 16, 17, or 18) determined in this color determination processing.

### <Free Game Mode Symbol Lottery Processing>

Next, with reference to FIG. 25, free game mode symbol lottery processing is described. FIG. 25 is a flowchart of the symbol lottery processing for the slot machine 10 according to the embodiment of the present invention.

First, the main CPU 200 extracts five random numbers for symbol determination based on the reel weight selected in the color determination processing in FIG. 27 (step S2511). In the case of making WHITE7s, the main CPU 200 selects the symbol determination table in accordance with the reel weight A in FIG. 16. In the case of making YELLOW7s, the main CPU 200 selects the symbol determination table in accordance with the reel weight B in FIG. 17. In the case of making RED7s or BLUE7s, the main CPU 200 selects the symbol determination table in accordance with the reel weight C in FIG. 18.

The main CPU 200 then determines to-be stopped symbols for the five mech reels M3a to M3e by lottery with the five random numbers (step S2513). That is to say, the main CPU 200 determines a to-be stopped symbol for the mech reel M3a with the first random number, determines a to-be stopped symbol for the mech reel M3b with the second random number, determines a to-be stopped symbol for the mech reel M3c with the third random number, determines a to-be stopped symbol for the mech reel M3d with the fourth random number, and determines a to-be stopped symbol for the mech reel M3e with the fifth random number.

In this step, in the case of making WHITE7s, the main CPU 200 determines five to-be stopped symbols with reference to the symbol determination table (the reel weight A) in FIG. 16; in the case of making YELLOW7s, the main CPU 200 determines five to-be stopped symbols with reference to the symbol determination table (the reel weight B) in FIG. 17; and in the case of making RED7s or BLUE7s, the main CPU 200 determines five to-be stopped symbols with reference to the symbol determination table (the reel weight C) in FIG. 18.

The main CPU 200 thus extracts five random numbers for symbol determination, and determines one symbol to be a to-be stopped symbol for each of the five mech reels M3a to M3e with reference to the symbol determination table in one of FIGS. 16 to 18.

Through the processing of step S2513, five to-be stopped symbols for the five mech reels M3a to M3e are determined. The five mech reels M3a to M3e are individually controlled to stop so that the determined to-be stopped symbols stop on the middle row of the symbol matrix (the middle row of the symbol display area 141d) in the processing of step S2213 in FIG. 22.

Next, the main CPU 200 stores the determined to-be stopped symbols for the individual mech reels to the symbol storage area provided in the main RAM 210 (step S2515).

As described above, in this symbol lottery processing, five to-be stopped symbols are determined with the probabilities according to the weights A to C indicated in FIGS. 16 to 18. However, all the weights can be specified as the same (equal probabilities) so as to define the drawing probabilities for the five to-be stopped symbols in accordance with the numbers of the symbols on the five mech reels M3a to M3e.

### <Specific Example of Determining Emission Colors>

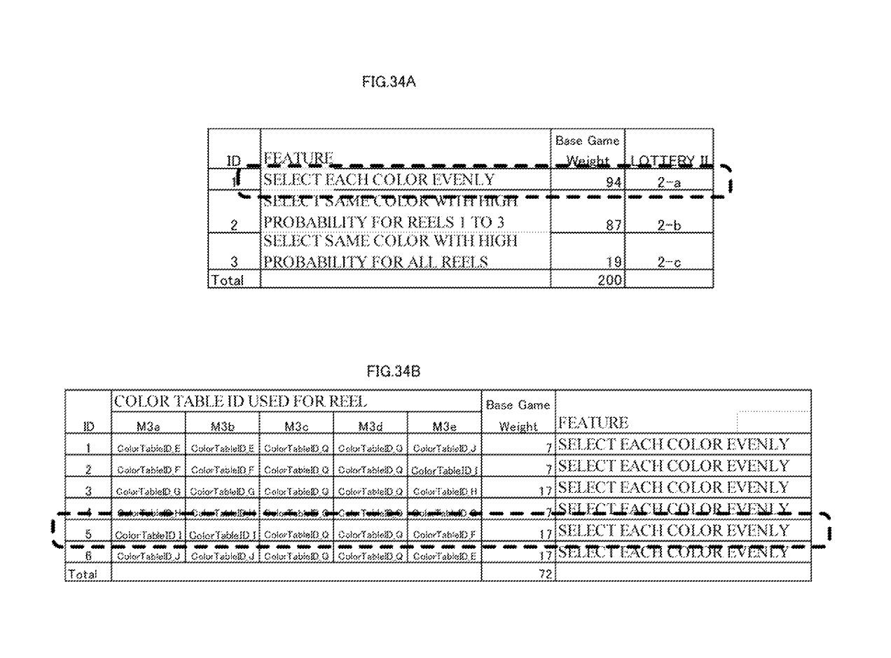

Hereinafter, a specific process of determining emission colors in the present embodiment is described with FIGS. 34 to 41.

First, the main CPU 200 determines one feature pattern from the feature pattern table determination table of FIG. 28 through the processing of steps S2611 and S2613 in FIG. 26. For example, the feature pattern ID is determined to be ID=1 through the processing of steps S2611 and S2613 in FIG. 26 (see FIG. 34A). That is to say, the feature pattern of “select each color evenly” is selected.

Accordingly, in the processing of steps S2615 and S2617 in FIG. 26, the main CPU 200 uses the reel pattern determination table of FIG. 29 out of the three reel pattern determination tables of FIGS. 29, 30, and 31.

Subsequently, the reel pattern ID is determined to be ID=5 through the processing of steps S2615 and S2617 in FIG. 26 using the reel pattern determination table of FIG. 29 (see FIG. 34B). That is to say, the color table for the mech reel M3a is determined to be ColorTableID_I; the color table for the mech reel M3b is determined to be ColorTableID_I; the color table for the mech reel M3c is determined to be ColorTableID_Q; the color table for the mech reel M3d is determined to be ColorTableID_Q; and the color table for the mech reel M3e is determined to be ColorTableID_F.

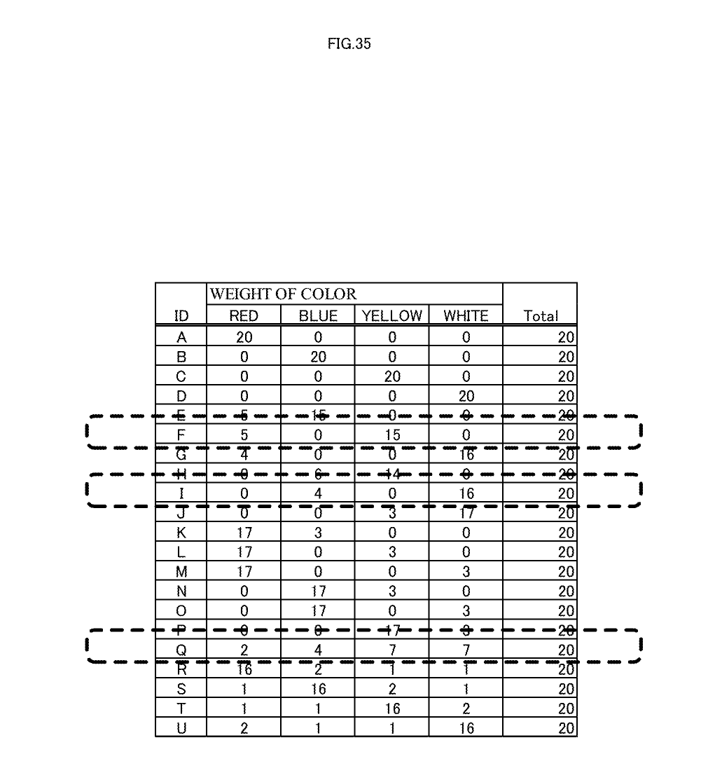

In other words, the main CPU 200 uses the color table of ID=I in determining colors for the mech reel M3a, the color table of ID=I in determining colors for the mech reel M3b, the color table of ID=Q in determining colors for the mech reel M3c, the color table of ID=Q in determining colors for the mech reel M3d, and the color table of ID=F in determining colors for the mech reel M3e (see FIG. 35).

Subsequently, the main CPU 200 repeats the processing of S2619 to S2629 in FIG. 26 to determine colors for all the 7s disposed on the five mech reels M3a to M3e.

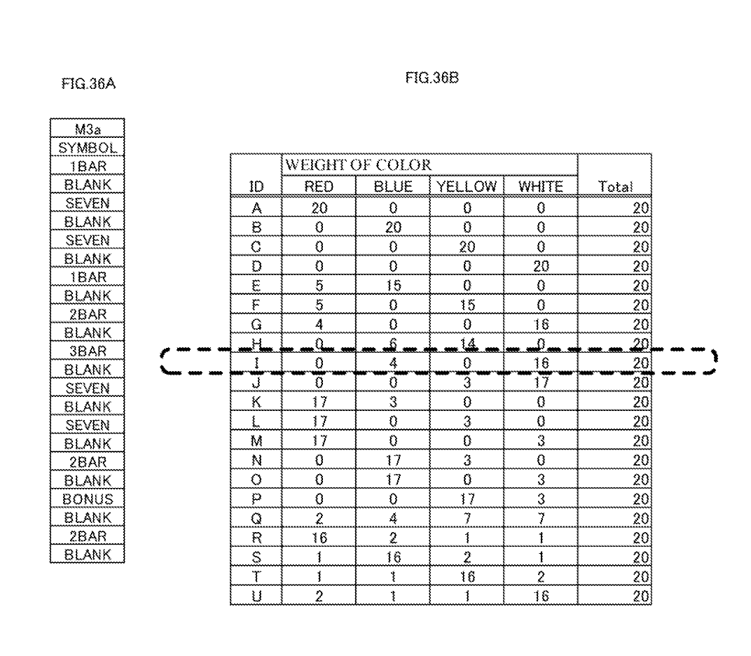

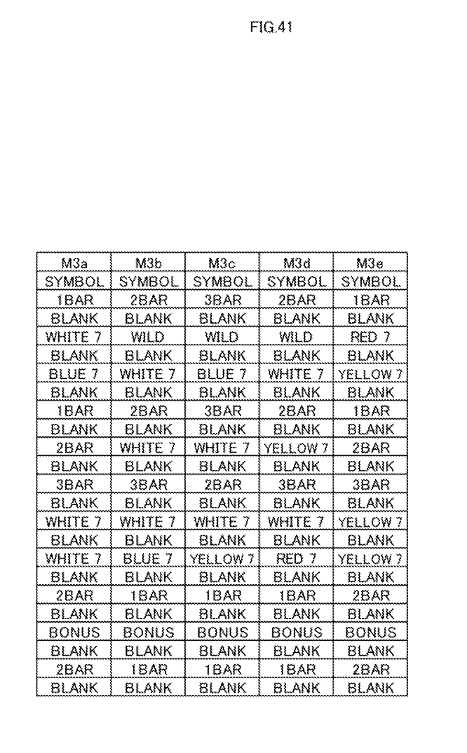

First, for the mech reel M3a, the main CPU 200 uses the color determination table of ID=I to individually determine colors for the four 7s of Nos. 2, 4, 12, and 14 as illustrated in FIG. 36A and FIG. 36B. In this example, the color for the 7 of No. 2 is determined to be white; the color for the 7 of No. 4 is determined to be blue; the color for the 7 of No. 12 is determined to be white; and the color for the 7 of No. 14 is determined to be white as shown in FIG. 41.

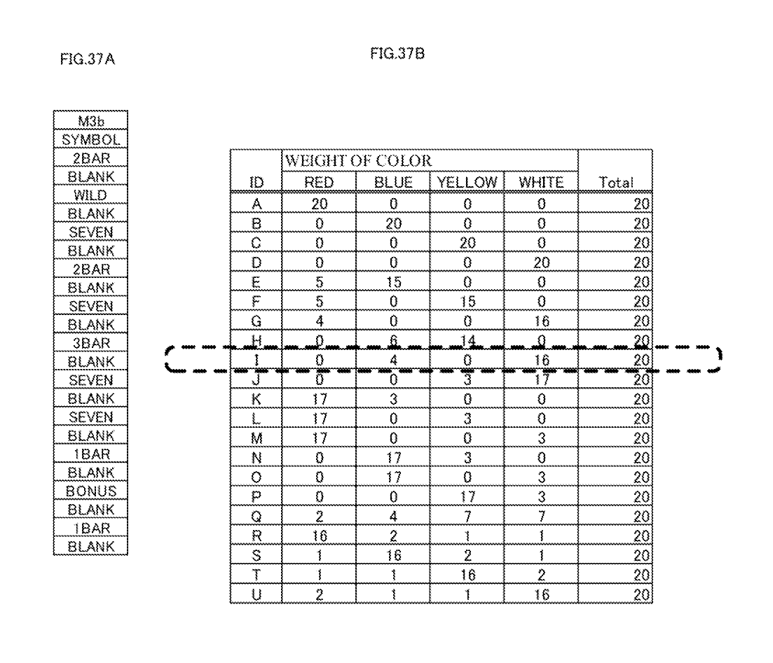

Next, for the mech reel M3b, the main CPU 200 uses the color determination table of ID=I to individually determine colors for the four 7s of Nos. 4, 8, 12, and 14 as illustrated in FIG. 37A and FIG. 37B. In this example, the color for the 7 of No. 4 is determined to be white; the color for the 7 of No. 8 is determined to be white; the color for the 7 of No. 12 is determined to be white; and the color for the 7 of No. 14 is determined to be blue as shown in FIG. 41.

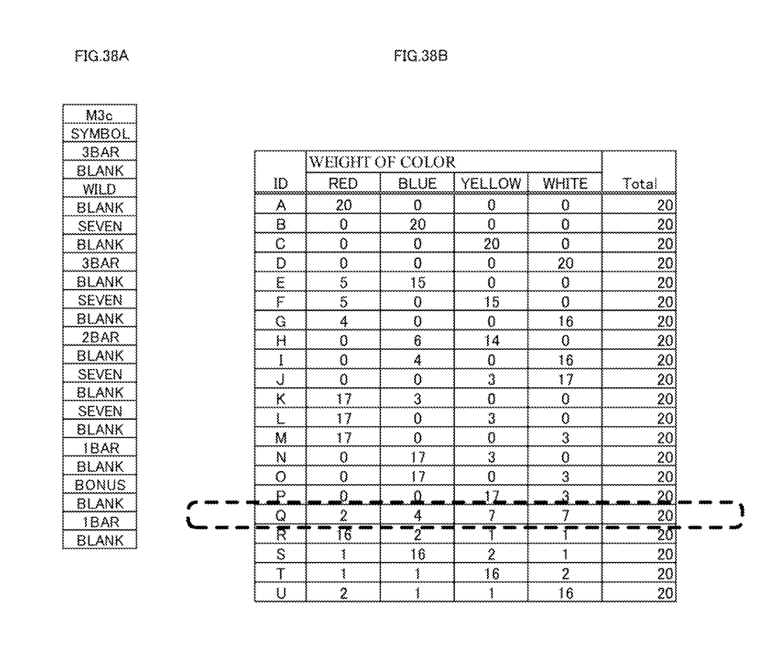

Next, for the mech reel M3c, the main CPU 200 uses the color determination table of ID=Q to individually determine colors for the four 7s of Nos. 4, 8, 12, and 14 as illustrated in FIG. 38A and FIG. 38B. In this example, the color for the 7 of No. 4 is determined to be blue; the color for the 7 of No. 8 is determined to be white; the color for the 7 of No. 12 is determined to be white; and the color for the 7 of No. 14 is determined to be yellow as shown in FIG. 41.

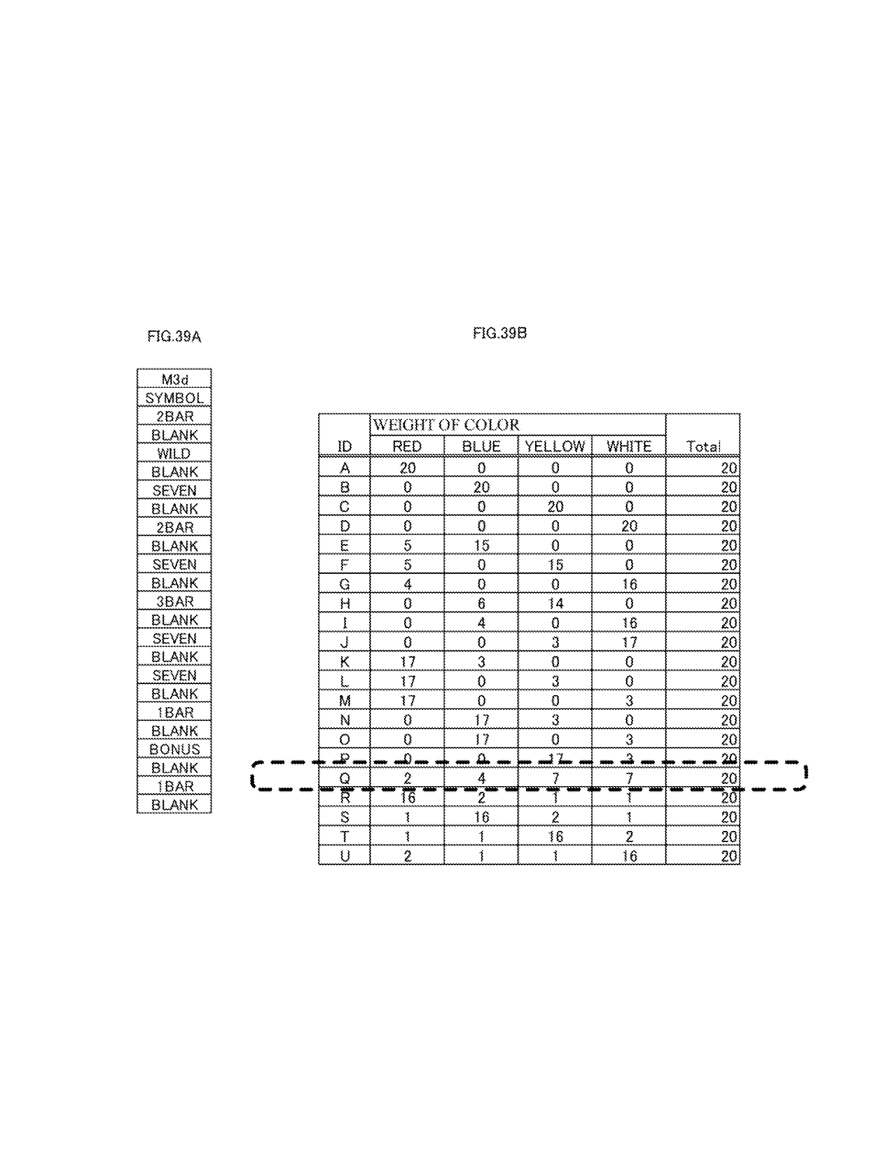

Next, for the mech reel M3d, the main CPU 200 uses the color determination table of ID=Q to individually determine colors for the four 7s of Nos. 4, 8, 12, and 14 as illustrated in FIG. 39A and FIG. 39B. In this example, the color for the 7 of No. 4 is determined to be white; the color for the 7 of No. 8 is determined to be yellow; the color for the 7 of No. 12 is determined to be white; and the color for the 7 of No. 14 is determined to be red as shown in FIG. 41.

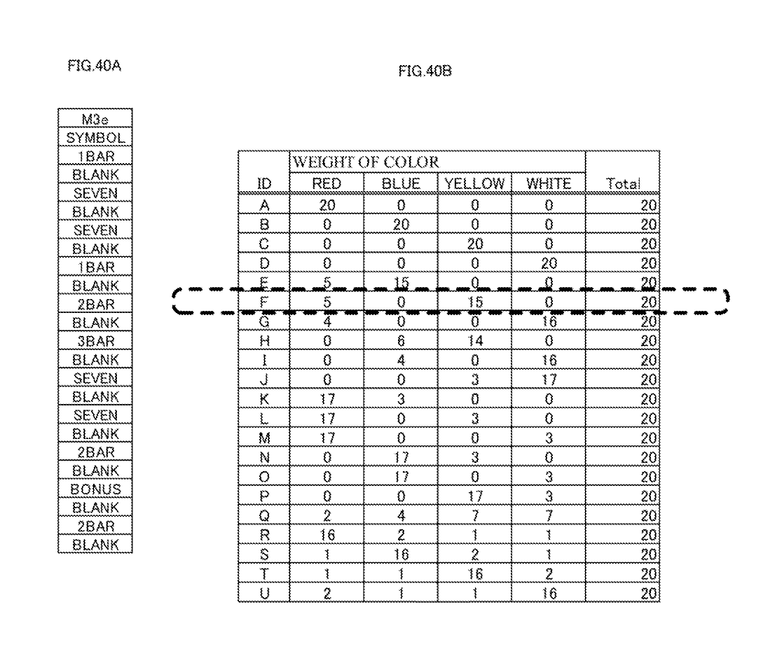

Next, for the mech reel M3e, the main CPU 200 uses the color determination table of ID=F to individually determine colors for the four 7s of Nos. 2, 4, 12, and 14 as illustrated in FIG. 40A and FIG. 40B. In this example, the color for the 7 of No. 2 is determined to be red; the color for the 7 of No. 4 is determined to be yellow; the color for the 7 of No. 12 is determined to be yellow; and the color for the 7 of No. 14 is determined to be yellow as shown in FIG. 41.

In this way, repeating the processing of S2619 to S2629 in FIG. 26 leads to determination of colors for all the 7s disposed on the five mech reels M3a to M3e as shown in FIG. 41.

Now assume that the to-be stopped symbols are determined to be No. 3 for the mech reel M3a, No. 12 for the mech reel M3b, No. 13 for the mech reel M3c, No. 11 for the mech reel M3d, and No. 6 for the mech reel M3e through the base game mode symbol lottery processing of step S1919 in FIG. 19. Through the symbol display control processing of step S1923 in FIG. 19, the mech reel M3a shows a WHITE7 (No. 2) on the top row, a BLANK (No. 3) on the middle row, and a BLUE7 (No. 4) on the bottom row; the mech reel M3b shows a BLANK (No. 11) on the top row, a WHITE7 (No. 12) on the middle row, and a BLANK (No. 13) on the bottom row; the mech reel M3c shows a WHITE7 (No. 12) on the top row, a BLANK (No. 13) on the middle row, and a YELLOW7 (No. 14) on the bottom row; the mech reel M3d shows a 3BAR (No. 10) on the top row, a BLANK (No. 11) on the middle row, and a WHITE7 (No. 12) on the bottom row; and the mech reel M3e shows a BLANK (No. 5) on the top row, a 1BAR (No. 6) on the middle row, and a BLANK (No. 7) on the bottom row.

### Other Embodiments

The foregoing embodiment has provided a method that performs color table determination processing first to determine one color table out of a plurality of color tables and subsequently performs symbol lottery processing to determine to-be stopped symbols. Determining a color table first enables presentation effects of emitting light using the determined color table so that the player can predict the determined color table.

The order of processing may be reversed by performing the symbol lottery processing first to determine to-be stopped symbols and subsequently performing the color table determination processing to determine one color table out of a plurality of color tables.

1. A gaming machine comprising:
a symbol display device for displaying a game result by rearranging a plurality of symbols;
a controller for executing games; and
a memory holding a plurality of tables,
the plurality of tables including:
a plurality of color determination tables for determining a color for decorating a symbol or a background of the symbol; and
a color selection tendency determination table for determining one color selection tendency from a plurality of color selection tendencies in determining a color for decorating a symbol or a background of the symbol, the plurality of color selection tendencies including a color selection tendency to select one color out of a plurality of selectable colors with high probability,
the plurality of color determination tables being defined to have different color selection tendencies, and
the controller being programmed to perform the following processing of:
(A-1-1) determining a color selection tendency by lottery with reference to the color selection tendency determination table;
(A-1-2) determining one color determination table from the plurality of color determination tables in accordance with the color selection tendency determined in the processing of (A-1-1); and
(A-1-3) determining a color for decorating a symbol or a background of the symbol by lottery with reference to the one color determination table determined in the processing of (A-1-2).

2. The gaming machine according to claim 1, wherein the plurality of tables further includes:
a symbol array table for defining a plurality of symbol arrays including the plurality of symbols; and
a color determination table combination table for specifying combinations of color determination tables associated with the plurality of symbol arrays one by one.

3. The gaming machine according to claim 1, wherein the controller is programmed to further perform the following processing of:
(B-1-1) accumulating a part of credits bet for each of the games; and
(B-1-2) providing the part of the credits accumulated in the processing of (B-1-1) in a form of a progressive payout when a predetermined winning pattern is completed with a specific kind of one or more symbols for which colors are determined with color determination tables.

4. The gaming machine according to claim 1,
wherein the games include games in a base game mode requiring a bet and games in a free game mode requiring no bet,
wherein the plurality of tables further include a free game mode table for determining a color for decorating a specific kind of symbols in the free game mode, and
wherein the controller is programmed to further perform the following processing of:
(C-1-1) determining a color for decorating all symbols of the specific kind with reference to the free game mode table when a game in the free game mode is being executed.
